(19) United States
(12) Patent Application Publication
(10) Pub. No.: US 2012/0060409 A1
(43) Pub. Date: Mar. 15, 2012

(54) BIO-DIESEL MANUFACTURE WITH A MICRO-REACTOR

(75) Inventor: Anthony J. Garwood, Mercer Island, WA (US)

(73) Assignee: American Beef Processing, LLC

(21) Appl. No.: 12/884,114

(22) Filed: Sep. 16, 2010

Related U.S. Application Data
(63) Continuation of application No. 11/490,861, filed on Jul. 21, 2006, now abandoned.
(60) Provisional application No. 60/783,963, filed on Mar. 20, 2006.
(60) Provisional application No. 60/786,959, filed on Mar. 29, 2006.
(60) Provisional application No. 60/799,515, filed on May 11, 2006.

(51) Int. Cl. C10L 1/02; B01F 7/00

(52) U.S. Cl. 44/307; 366/292; 366/297

(57) ABSTRACT

Methods and apparatus for producing bio-diesel from triglycerides and lower alcohols, desirably in the presence of liquid or supercritical CO₂, are provided. The apparatus are designed to enhance the miscibility of the triglycerides with lower alcohols.

### CROSS-REFERENCES TO RELATED APPLICATIONS

This application is a continuation of U.S. application Ser. No. 11/490,861, filed Jul. 21, 2006, incorporated herein by reference in its entirety, which claims priority to U.S. Provisional Application No. 60/783,963, filed Mar. 20, 2006; U.S. Provisional Application No. 60/786,959, filed Mar. 29, 2006; and U.S. Provisional Application No. 60/799,515, filed May 11, 2006, the entire disclosures of which are incorporated herein by reference.

### FIELD OF THE INVENTION

The present invention relates to the improved and efficient manufacture of renewable fuels and in particular, the production of normally liquid, fluid, renewable fuels and more specifically bio-diesel, from animal and plant fats or triglycerides by the method of trans-esterification. The production methods disclosed may use high pressure in miniaturized or micro and nano (when channels are below about 100 μm diameter) chemical processing apparatus. The purpose of the apparatus is to reduce the floor space needed to install the complete production system, when compared with the typical bio-diesel processing plant used previously and/or to create conditions under which triglycerides and lower alcohols mix efficiently.

### BACKGROUND OF THE INVENTION

Hitherto, bio-diesel has been produced in ambient conditions by providing a catalyst, such as sodium hydroxide or potassium hydroxide, blended with an excessive quantity of methanol and a quantity of refined animal or plant fat; most preferably the fat or triglycerides are heated to about 120° F. then the combined liquids and catalyst are transferred to a storage vessel or reactor and agitated for up to approximately 7 hours or more, until the animal fat (triglycerides) has reacted with as much methanol as the triglycerides have chemical bonds to allow and the reaction phase of bio-diesel production is complete. Bio-diesel produced in this way requires copious quantities of clean water to wash any detergents, such as sodium stearate (otherwise known as soap) from the fluid bio-diesel that will likely be present in small quantities. The excess methanol and catalyst is then allowed to stratify after transfer to a suitably, elongated, tall vessel, or separation column, where the bio-diesel (e.g., specific gravity=approximately 890 Kg/M³) can stratify into layers according to the specific gravity of each fluid present; therefore, the lowest stratified layer would be glycerol (specific gravity=1126 kg/M³) with water (specific gravity=approximately 1000 Kg/M³) directly above the glycerol, bio-diesel fatty esters (approximately 890 Kg/M³) above the water and the surplus methanol (specific gravity=approximately 791.3 Kg/M³) floating above the bio-diesel. The stratified and separated fluids can then be de-cantered for subsequent use as intended, with recycling of surplus methanol and the bio-diesel for use as the intended liquid fuel.

### SUMMARY OF THE INVENTION

One aspect of the present invention is directed to a process for the production of bio-diesel that uses liquid or fluid, dense phase CO₂ as an alternative or additional catalyst. The use of liquid or fluid, dense phase CO₂ (L-CO₂) significant reaction time reduction and also facilitates a more complete reaction of triglycerides with a lower alcohol, such as methanol or ethanol, followed by an improved separation of firstly, clean bio-diesel and secondly, glycerol from the remaining fluid comprising excess methanol and/or ethanol, catalyst, L-CO₂ and impurities. More specifically, the improved separation process comprises an enclosed, pressurized, vertically disposed centrifuge using liquid CO₂ as a liquid medium for separation of crystallized bio-diesel and glycerol. The use of a pressurized centrifuge is described in patent applications by the present inventor, for example, as in U.S. Patent Application Publication No. 2005/0042346 and in International Patent Application No. PCT/US2005/043507, filed Dec. 2, 2005, which was published on Jun. 8, 2006, under Publication No. WO 2006/060596. The above patents and the disclosures of all patent applications in the name of the present inventor are herein expressly incorporated by reference in their entirety.

The invention relates to the use of micro or nano technology in the production of renewable fuels and, in particular, of bio-diesel and all corresponding by-products. In one embodiment of the invention, a stream of low cost, readily available, excess beef fat feedstock (a bio-diesel feedstock) is transferred by any suitable pumping means under controlled pressure into manifolds (or ports), which feed micro-size conduits (or reaction tubes). This process reduces reaction time since the close proximity of the reagents in the conduits enables reactions to occur more rapidly and also produces controlled quantities of materials of higher value, such as bio-diesel, more rapidly than systems that use, for example, sodium hydroxide blended with triglycerides in a large tank or vat system. Furthermore solid catalysts such as silica can be fixed to the inner surface of the reaction conduits and vessels. This invention includes preferred conditions to rapidly mix reagents by way of static structures assembled from a series of plates (or discs) wherein each plate has depressions (or recesses) with profiles that align with depressions having corresponding mirrored profiles in each adjacent plate. Typically, the plates are manufactured from, most preferably as a first instance, stainless steel and secondly, plates formed under high pressure such as by way of compression and/or injection molding of suitable polymers. A series of conduits are machined or molded such that when several plates are stacked together, a series of uniform cross-section conduits traversing all plates, enable the transfer of micro quantities of chemical feed stock through the enclosed spaces in which controlled reactions take place. After the reactions are complete, the newly formed materials are then transferred via a series of conduits connected to manifolds that traverse the stacked plates in a similar fashion to those provided for the feed stock materials. A purpose of this equipment is to enable the manufacture of small quantities of chemicals that may otherwise require very costly apparatus and processes.

An additional benefit of the process disclosed herein includes the reduction in the quantity of water ordinarily required for preparing bio-diesel manufactured with sodium hydroxide or potassium hydroxide as catalysts. Very large quantities of water are required to “wash” bio-diesel prior to consumption in, for example, an internal combustion engine. Sodium hydroxide and/or potassium hydroxide are potentially damaging to, for example, injection and all exposed metal surfaces within an internal combustion engine. Corrosion can occur and the life of the subject internal combustion engine will be reduced. The disclosure below provides details of a process incorporating sub and/or super-critical CO₂ as the catalyst. L-CO₂ blended with the other components, which may include a quantity of water, required to produce bio-diesel after the reaction has occurred, can provide a low pH value such as 5, 4, 3 and even as low as about 2.9. Elevated pressure on the order of 500 psi at about 34° F. to 36° F. may be required to create the conditions under which such low pH will occur; conversely, when pressure is released under controlled reduction to ambient pressure, any CO₂ that remains with the bio-diesel will quickly boil off, leaving no more than the bio-diesel and glycerol present.

A second aspect of the invention is directed to an improved separation process that uses an apparatus that comprises a single or series of interconnected hydro-cyclones or more specifically, enclosed and sealed cyclones using liquid/fluid carbon dioxide instead of water, wherein the cyclones are suitably enclosed, sealed and pressurized, save the input and output ports. The input and output ports are connected to conduits which are enclosed by suitable valves, to maintain the carbon dioxide at a selected pressure such that the specific gravity of the liquid carbon dioxide is maintained at a selected level, such as 58 lbs. closed cubic foot. The cyclones are connected to, most preferably, centrifugal pumps, wherein a single centrifugal pump is connected via a conduit to the upper inlet of a cyclone. The fluid carbon dioxide containing triglyceride-containing solids, such as ground beef, in suspension is transferred via a pressurized conduit which is connected to the cyclone. The ratio of solids in suspension to the carbon dioxide fluid can be on the order of one part liquid carbon dioxide to 4 or 5 parts solids in suspension. In the case of ground beef, the particles of ground fat can be separated from the lean beef particles. The fat, or more specifically the fatty adipose tissue including some inseparable lean beef (muscle striations), is then processed by applying heat, then centrifuging and separating the beef oil from the other solids. The solids are then chilled and blended with other lean food products and the beef oil is used in the production of bio-diesel as disclosed herein. The cyclones incorporated in the process of beef oil extraction are described in greater detail below.

The foregoing aspects and many of the attendant advantages of this invention will become more readily appreciated by reference to the following detailed description when taken in conjunction with the accompanying drawings.

### BRIEF DESCRIPTION OF THE DRAWINGS

FIG. 1 shows a full set of laminae in an exploded view, according to the present invention;

FIG. 2 shows a three dimensional view of a collection of four plates arranged to provide a series of connected conduits within which controlled chemical reaction can take place, according to the present invention;

FIG. 3 shows the outline of conduits created when the apparatus of FIG. 2 is assembled. Inlet conduits connected via manifolds and enclosed spaces to outlet conduits arranged adjacent to one another, according to the present invention;

FIG. 4 shows cross sectional illustrations of the conduits and spaces enclosed within four corresponding plates that are stacked and clamped together, according to the present invention;

FIG. 5 shows the behavior of three fluid streams combined into a single stream shown immediately after combining and then after transfer into the enclosed space of a reaction chamber, according to the present invention;

FIG. 6 shows a diagrammatic representation, generally in plan view, of an application where the present invention is applied, according to the present invention;

FIG. 7 shows a preferred embodiment of an apparatus, wherein a centrifugal reaction process is illustrated, according to the present invention:

FIG. 8 shows the chemical reaction of triglycerides and methanol to produce fatty esters and glycerol, according to the present invention;

FIG. 9 shows a 3D view of an apparatus designed for the production of bio-diesel, according to the present invention;

FIG. 10 shows a preferred embodiment of an apparatus, wherein a rotating reaction member provides mixing means according to the present invention.

FIG. 11 is diagram showing steps in a production configuration that can be arranged to produce bio-diesel and other components of a chemical reaction plant matter.

FIG. 12 a plan view of a diagram showing a preferred method of bio-diesel and glycerol production.

FIG. 13 is a table showing a range of temperatures and pressures that can be maintained to achieve maximum efficiency of a particular reaction.

FIG. 14 shows a hydrocyclone that may be used to separate lean beef from beef fat in accordance with the present invention.

FIG. 15 shows a cross-sectional view of the hydrocyclone of FIG. 14.

### DETAILED DESCRIPTION OF THE PREFERRED EMBODIMENTS

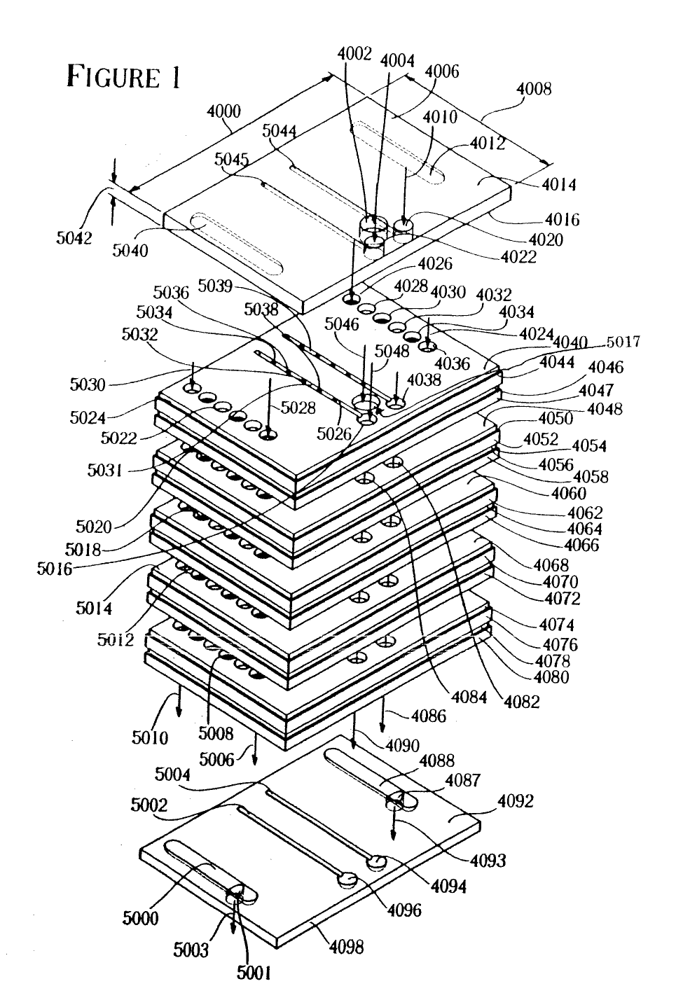

The apparatus and processes described herein are most preferably used for the production of bio-diesel. The apparatus shown herein comprises a series of three dimensional views of a micro reactor with details showing the manifolds and conduits providing a general understanding of the operation and approximate size of the apparatus. 4000 and 4008 in FIG. 1 represent length by width, respectively, of the plan view of a stacked and assembled grouping of laminae wherein the diameter of 4000 equals approximately one inch and the diameter of 4008 is ¾ of an inch. The thickness of a typical laminae is represented by 5042 and is on the order of 1/16 of an inch. The diameter of manifold 4020 is approximately ⅛ of an inch. Hence, the equipment described herein is generally referred to as “micro technology”.

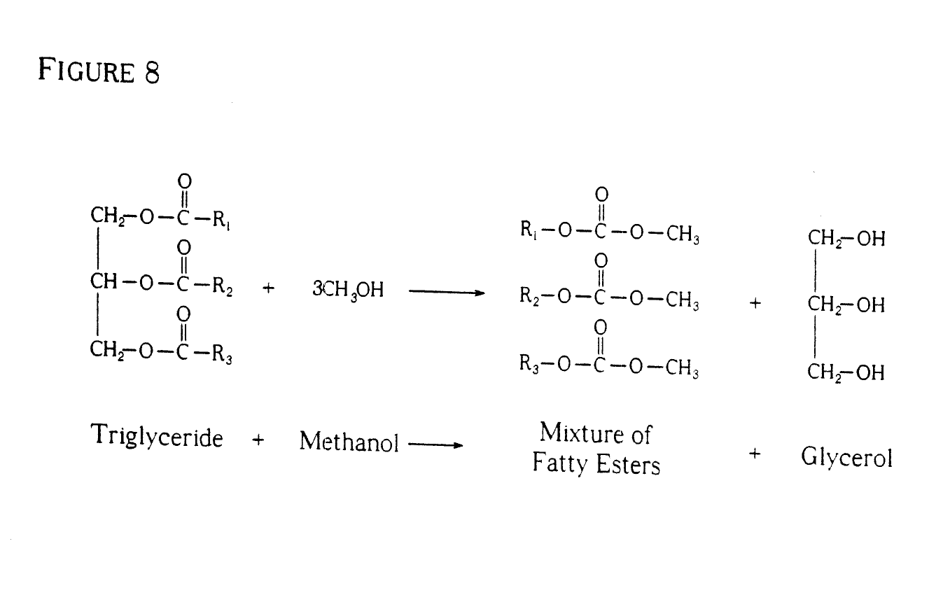

The reaction residence time during which the blended materials required for the reaction are retained in the reactor (vessel) of a typical macro bio-diesel production system is on the order of 7 hours, whereas the reaction time for the micro-technology described herein can be on the order of 20 seconds. It can therefore be seen that relatively substantial quantities of bio-diesel can be produced by the micro equipment when compared with macro equipment production rates. An integrated micro structure is provided by stacking several flat sections (or plates) of selected material, wherein each flat section is machined or molded to provide channels, vessels, ports and conduits that may communicate directly with adjacent flat sections. The inlet and outlet ports of each flat section are located in common positions such that when stacked together the outlet port of a first flat section can communicate directly with the inlet port of a second adjacent flat section, which are connected together such that their inlet and outlet ports are connected by a series of channels and enclosed chambers in which the chemical reaction required to produce renewable fuels can take place. In this way, flat sections are connected together via outlet and inlet ports and the inlet and outlet ports of each flat section are connected by a series of channels and enclosed chambers specifically designed to facilitate the chemical reaction required to produce renewable fuels or bio-diesel. The stacked laminae formed from the flat section (with slots, perforations, grooves, recesses, channels and vessels), are carefully arranged to provide a series of reticulating conduits within which, when stacked and held firmly together, immiscible and/or miscible fluids alike, can be blended together thoroughly in the micro channels, vessels and miniature reactors to ensure contact between, in particular, immiscible fluids such as fluid beef tallow and methanol or ethanol. Such thorough mixing can occur with dissimilar materials that ordinarily may repel each other. The reaction to produce bio-diesel and glycerol is shown in FIG. 8.

Additionally, it is a purpose of the new technology disclosed herein to facilitate enhanced quality of food and, in particular, the quality of beef harvested, typically, from either steer or heifer sources wherein these animals are slaughtered at the age of about 30 months or less or more, enhancing beef flavor, tenderness, mouth-feel and aroma while facilitating the low cost production of low cost bio-diesel from animal fat harvested from the slaughtered animals. Animal fat sources most preferably from cattle and having been lot fed to attain a body weight greater than 1,200 lbs will be more abundant than if the animals are smaller. Typically, steer and heifers can be transferred to lot feeding facilities at the age of, for example, 1 year to 2 years and then the animals may be retained in the lot feeding facility for a period of several months, but generally, significantly less than 12 months. The period of time that the cattle are held is determined by the weight gain of individual animals. The animals will generally be released for slaughter when they reach an approximate weight of 1,200 lbs. Some cattle attain this weight by or before the age of 15 months, whereas others may take significantly longer and in some cases never reach this target weight. So, it is a purpose of this invention to provide an incentive to cattle “feeders” to retain cattle at the lot feeding facility for a period of time determined by the attained body weight of each animal. Furthermore, it is intended to encourage feed lot operators to allow cattle to be finished and released for slaughter only when a significant quantity of beef fat has become available for harvesting from the carcasses after slaughter. More particularly, it should be noted that cattle around the age of 15 to 24 months have a capacity to consume vast quantities of feed. Little exercise is required for the animal located in a feed lot since feed is available within a short distance, even from the furthermost point in each pen of the feeding lot. Therefore, little exercise is possible, although sufficient to satisfy the natural requirements of cattle, which are quite different from other animals housed in intensive breeding and rearing facilities. Briefly, intensive breeding and animal rearing procedures comprise enclosure of, for example, sows in breeding pens that restrict them from even turning around. Such an example is typical and the pigs have been bred by selecting those animals with the most suitable characteristics for enclosing within the intensive rearing facility. Conversely, cattle cannot be intensively farmed, particularly during the first few months of the animal's life, at least not with the currently predominant cattle breeds and they must be enclosed within pens having at least one hill that they can climb and also the provision of feed and water close by. The typical heifer and steer body weight of 1,200 lbs enables harvesting of more than 200 lbs of fat (white adipose fatty tissue) from which proteins, collagen and connective tissue must be separated from the fatty tissue prior to the production of bio-diesel from said fat. Approximately 8 lbs of oil (tallow; in particular, beef tallow having no solids or other contaminants) with a proportioned quantity of methanol (see below for specific quantities) can produce about one gallon of bio-diesel.

It is a purpose of this present invention to provide encouragement to cattle feed lot operators to retain animals for a longer period and in the feed lot facilities so that the quantity of fat yielded from each animal is increased. It is anticipated that such increase would be equal to at least a 50% more than is currently available. The benefit of this prospect far exceeds the associated costs. A 1,200 lb steer or heifer consumes vast quantities of feed; however, the conversion rate can exceed 25% at this stage of their life cycle. Therefore, adopting this method of producing fat for production of bio-diesel is substantially less costly than, for example, sourcing similar fat from plant matter such as seeds or beans (such as soy beans). Costs inevitably incurred in the production of oil derived from plant matter include the crushing plant costs, which is on the order of $60 million. Therefore, to extract a quantity of oil from virtually any plant source requires the cultivating of the appropriate plant (e.g., soy beans) to be harvested. The separation of seeds or beans from the supporting plants then crushing the beans or seeds, results in a relatively small quantity of extracted oil when compared with the value or cost of entire living plant, most of which is lost. In fact, greater than 75% of the energy stored in a plant having been derived via photosynthesis from the solar source, is lost. When compared with fat derived from an animal source, it can be seen the plant matter wasted in producing oil by way of plant cultivation is 75% which is comparable to the feed loss with a 25% conversion rate. However, the conversion rate of feed in cattle of 20 months old is greater than 25% and the animal fat source does not require new fat extraction crushing plant and equipment.

Desirably, bio-diesel shall be produced according to the processes disclosed herein by the trans-esterification of triglycerides harvested from cattle (or plant matter of suitable type or genus). In one embodiment, CO₂ is used as a catalyst in suitable proportion to the beef fat or oil at appropriate temperature and pressure as required to maintain the CO₂ phase most suitable for the maximized bio-diesel production. These processes may use micro and/or nano technologies such as those recently developed at ONAMI Pacific North West Laboratories or Oregon Nano Science and Micro Technology Institute. ONAMI have developed a micro scale production plant for the manufacture of bio-diesel from plant materials. In addition, SafeFresh Technologies, LLC have developed processes incorporating CO₂ as the catalyst, medium, refrigerant, antimicrobial and propellant, all employed in a process that has now reached commercial operation. By combining these two separate technologies, the investor has developed an efficient process for bio-diesel production. The processes may utilize micro technology such as the ONAMI bio-diesel micro technology, as disclosed in association with FIGS. 1-5. Notably, unlike the technologies developed by ONAMI wherein catalysts such as silicon, sodium hydroxide, potassium hydroxide and other solid structures form a component of the micro equipment developed by ONAMI, the present methods may displace other more conventional catalysts with L-CO₂. The reactions (between the triglyceride fat molecules and methanol and/or ethanol) can be enabled when liquid CO₂ or, alternatively, dense phase critical CO₂ which is thoroughly miscible with said triglyceride animal fats is combined with a proportionate quantity of methanol and/or ethanol.

In some embodiments, the reaction between methanol and/or ethanol and triglycerides with a suitable catalyst yields approximately 20 grams of glycerol with every 100 grams of bio-diesel. Furthermore, it is preferable that excessive methanol and/or ethanol be provided and therefore, the residual methanol and/or ethanol will comprise a component of the resultant mixture. Said mixture contains bio-diesel, glycerol, methanol and/or ethanol and CO₂. In any event, the resultant mixture of liquids is desirably separated prior to using the bio-diesel as a liquid fuel.

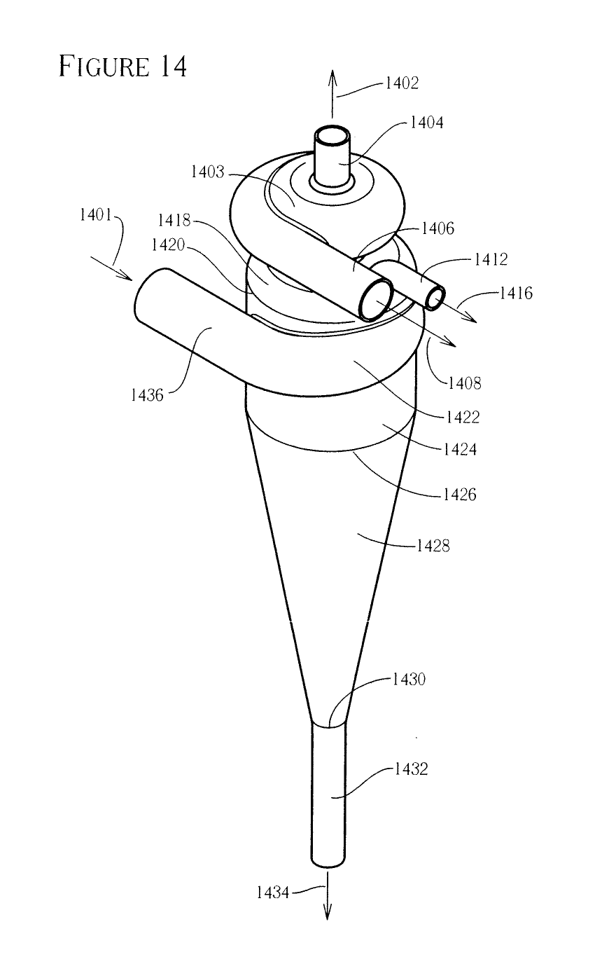

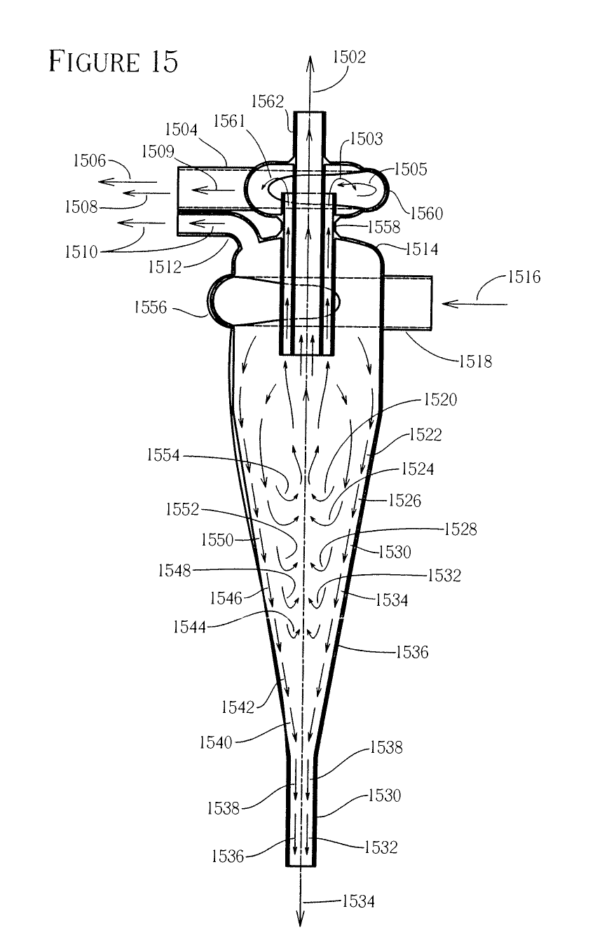

In particular, the apparatus disclosed in association with a series of figures describing an enclosed pressurized vertically disposed (or horizontally disposed) decanter-style centrifuge arranged to separate liquids and solids from liquids and solids into separated, isolated streams. In one preferred embodiment, the separation of glycerol and bio-diesel can be achieved by “spray-freezing” the resultant fluid as disclosed herein. The separated streams of methanol, ethanol, water and CO₂ can then be recycled with bio-diesel transferred into suitable storage vessels. A hydrocyclone separation apparatus is shown in FIGS. 14 and 15.

Referring now to FIG. 1, a three dimensional view of an apparatus comprising a series of plates or lamina such as 4040 and 4044 are arranged in symmetrical groups of 4× lamina each, between an upper end plate 4014 and a lower end plate 4092. The view in FIG. 1 is “exploded” and 5 groups of 4× lamina, or flat sections, are shown in an expanded view and spread apart. The apparatus when in closed position, such that all laminae are held in tight contact with adjacent lamina, held together by said end lamina 4014 and 4092 in such a manner that suitable clamps exert such pressure so as to close end plate 4014 toward opposing end plate 4092 with a closing pressure sufficient to inhibit leaking of any pressurized fluids that may be transferred through ports, conduits and vessels provided within the assembled flat sections, generally provides a fully enclosed system, other than inlet and outlet ports which are also sealed tight in connections to corresponding supply and removal conduits, preventing escape of any fluid to atmosphere, having conduits communicating and connected in a manner that is described as follows:

Port 4002 connects directly with a series of ports having a center line parallel with arrow 5046 and extending through all flat sections, plates or lamina with an end plate 4014 through plate 4080 and enclosed at a lower end by plate 4092, thereby creating a conduit into which fluid can be transferred, wherein said fluid can transfer via conduits parallel with manifolds 5044 and 5045, and all manifolds of similar length to 5044 and 5045, wherein said manifolds connect each group of conduits together such that the fluids transferred therein can be extracted by connecting to extraction conduits (such conduits not shown). Ports 4020 and 4022 connect directly with ports 4038 and 5016 respectively, then plates 4082 and 4084 respectively and so on to provide two parallel conduits in direct communication with a series of perpendicular conduits such as those defined by recesses 5031 and 5039. Recess 5031 communicates with a series of connection tubes 5026, 5038, 5036, 5034 and 5032 with similar and corresponding connection tubes communicating with recess 5039. It can therefore be understood that fluid transferred into port 4022 in the direction shown by arrow 5048 can enter recess 5031 and from recess 5031 into connection port 5026, etc. Similarly, fluid transferred in the direction shown by arrow 4010 into port 4020 can flow into conduit segment 4038 and then into recess 5039 and so on. The conduits or recesses arranged between laminae such as 4014 and 4040 are arranged to communicate in such a manner that bio-diesel and a proportionate quantity of glycerol can be manufactured in the apparatus. When fluids comprising beef fat are blended with a proportionate quantity of liquid CO₂ then transferred into port 4002, a quantity equal to about 20% by volume, for example, of fluid transferred into port 4002 is transferred via ports 4020 and 4022. The conduits provided are arranged to combine a suitable quantity of methanol and/or ethanol with a corresponding quantity of blended liquid CO₂ and beef tallow such that contact between molecules of beef fat and molecules of methanol and/or ethanol occurs, resulting in a reaction between the methanol and/or ethanol and the triglyceride molecules of the beef tallow, resulting in production of bio-diesel which then transfers into reaction chambers, the detail of which shall be provided below.

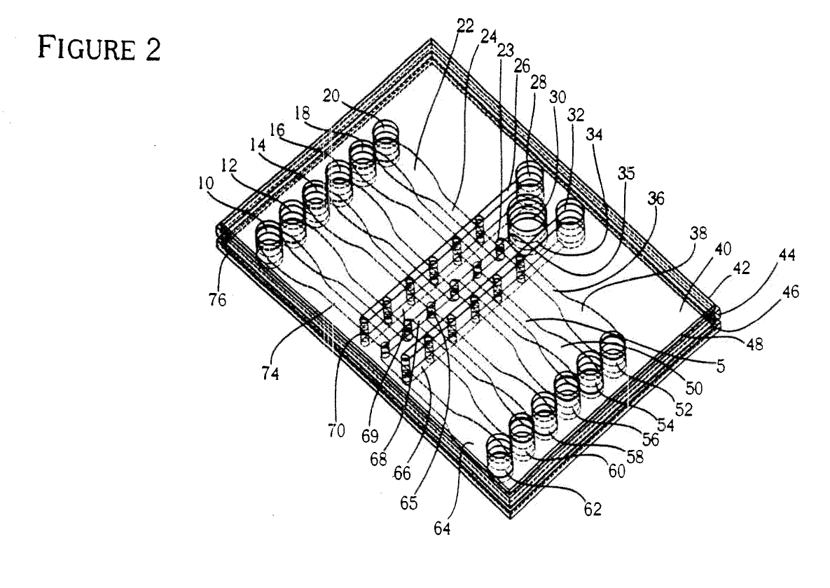

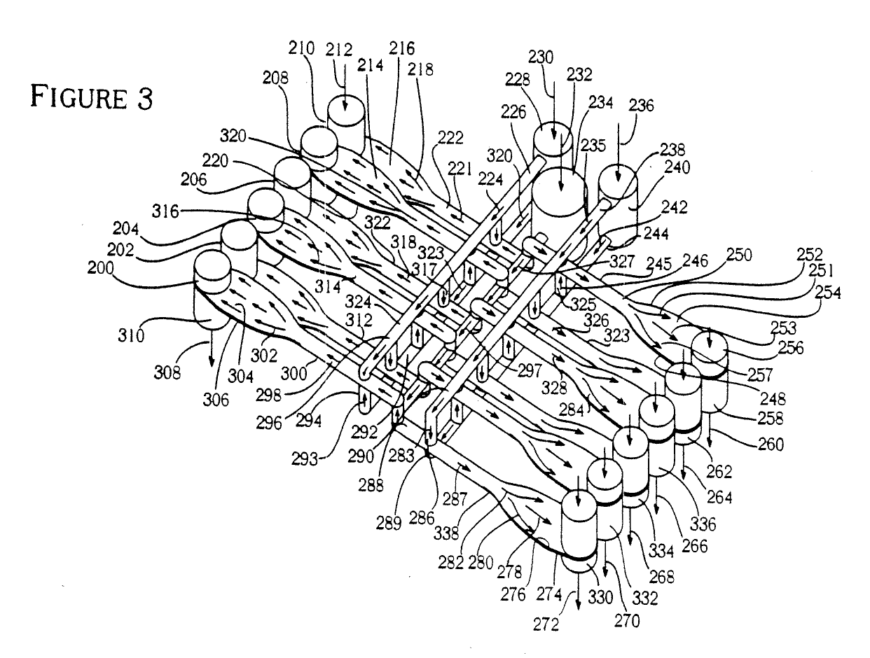

Five assembly groups of lamina are shown in FIG. 1 in exploded view between end plates 4014 and 4092 including a first assembled group of plates 4040, 4044 and 4046. Each group of lamina are similar and are profiled with slots, recesses and ports that correspond with the profiles of adjacent lamina to provide a series of conduits and reaction tubes connected directly with input ports 4002, 4004 and 4020 which can communicate there through with extraction ports such as 4026, 4028 through 4036 and also a corresponding series of ports including port 5022. FIG. 2 shows the outline of a similar grouping of laminae such as 4040, 4044, 4046 and 4047 (of FIG. 1) with the outline of extraction ports 4026, 4028, 4030, 4032, 4034 and 4036 (of FIG. 1) and input connection ports 4038, 5016 and 5017 which together correspond with ports 28, 32 and 30 (of FIG. 2), which connect to distribution conduits (or manifolds) such as 5031 and 5039 (FIG. 1), transfer tubes such as 5034, 5036 and 5026, which connect with reaction tubes such as 245 or 288 in FIG. 3 which in turn connect with reactor vessels or reaction chambers such as 274 or 254 in FIG. 3 which collectively communicate directly between said input ports and output ports of an output manifolds of FIG. 1. Said series of 5 laminate groupings shown in exploded view and spaced apart in-line between end plates 4014 and 4092 (of FIG. 1) are each constructed and arranged in like fashion as the outline of members 40, 44, 76 and 46 as shown in FIG. 2, all generally arranged such that when assembled and held compressed, by any suitable set of tie-rods (not shown) for example, between said end plates 4014 and 4092, bio-diesel can be manufactured within such an enclosed series of micro channels and conduits with an input stream provided via feeding tubes connected directly to manifolds such as 4012 and 5040 of FIG. 1.

Referring again to FIG. 1 and, in particular, inlet ports 4002, 4020 and 4022, it should be noted that fluids transferred therein will follow the micro conduits such as 5031 and 5039 and then through ports such as 5036 and 5034 and after reticulating through the micro channels and reaction chambers, bio-diesel and glycerol will transfer through extraction ports such as 5008 in the direction shown by arrows 5006 and 5010 to connect with manifold 5000 or manifold 4088 and then through outlet ports such as 4087 in the direction shown by arrow 4093 provided in manifold 4088 or, alternatively, through outlet port 5001 of manifold 5000 in the direction shown by arrow 5003.

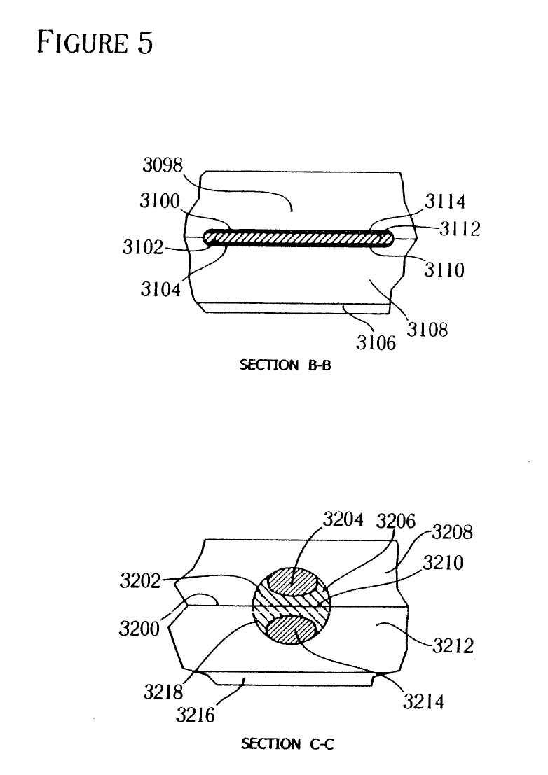

Referring now to FIG. 2, ports 28 and 32 are arranged to provide communication with reactor vessels such as 22 and 38. First, fluid comprising a blend of refined beef tallow and any suitable fluid catalysts such as L-CO₂, sodium hydroxide or potassium hydroxide blended together can be transferred through port 30. Port 30 communicates with conduit 35, enabling transfer of said first fluid to be transferred via conduit 35 and then into connection tube 23 and into reaction conduit 24, followed by reaction vessel 22. The reaction vessels 22, 38 and 50, for example, which are connected to reaction conduits 24 and 36, are typical examples of preferred profiles for most efficiently producing bio-diesel from the fluids provided therein. Conduits 35, 26 and 66 are examples of conduits provided to transfer fluid prior to reaction together. In particular, fluids transferred via port 30 combine with fluids transferred via ports 28 and 32 within reactor conduits such as 24 and 36 which, in turn, communicate with reaction vessels 22 and 38 respectively and similar to, for example, reactor conduit 74 or reactor vessel 64. Fluids transferred via port 30 are ultimately sandwiched above and below, in intimate contact with fluid transferred via ports 28 and 32 as described below in association with FIGS. 3, 4 and 5, and in particular, as shown in FIG. 5, section “B-B”.

Referring now to FIG. 3, the outer profile of a complex manifold-like image is shown with solid lines, projected in a three dimensional view. Again, the outline shown in FIG. 3 corresponds to the groupings of plates shown in three dimensional view in FIG. 2 which also corresponds with the assembly of 5 groupings of 4 laminae each (such as 4040, 4044, 4046 and 4047) shown in FIG. 1.

The three dimensional image shown in FIG. 3 comprises a series of input ports 228, 234 and 240 (also referred to as manifolds) which correspond with inlet ports 30, 28 and 32 as shown in FIG. 2. Fluid transferred into port 234 in the direction shown by arrow 232 ultimately becomes sandwiched between fluid transferred via port 228 in the direction shown by arrow 230 and port 240 in the direction shown by arrow 236. Fluid transferred via port 234 is ultimately sandwiched between fluid transferred via port 228 and fluid transferred via port 240 in such a way that contact between molecules of the fluids enables the rapid production of bio-diesel according to the reaction shown in FIG. 8.

In one preferred embodiment, a blended fluid comprising a catalyst such as L-CO₂ combined with ethanol and/or methanol collectively maintained at a suitable pressure such as 1,100 PSIG or greater and temperature such as 90° F. or greater (to ensure fluid L-CO₂ is maintained in a suitable, super critical phase) is transferred at a controlled and adjustable rate into ports 28 and 32 of FIG. 2 which connect with lateral conduits 34 and 66 and also 26 and 69. Corresponding lateral conduits are arranged in pairs with, for example, lateral conduit 26 located above reaction conduits 24 and 74 with vertically disposed connection tubes such as 70. A supply of fluid comprising beef fat having been separated from substantially all other source material solids (e.g. proteins and connective tissue) is transferred under controlled pressure (e.g., about 500 psi) through port 30 which, in turn, connects with a lateral conduit such as 68 and then with connection tubes such as 23 and 65 before direct transfer at a perpendicular disposition to a reaction conduit such as 24. The reaction conduit 24 connects directly to reactor vessel 22 which has a profile flattened to ensure a broad exposure between fluids transferred there through.

Referring to FIG. 2, it can be seen that a controlled supply of liquid beef fat transferred via port 30 and into lateral conduit 68 can be pumped under selected pressure into reaction conduits such as 74, 24 and 36. Said reaction conduits connect directly to enclosed flattened reaction vessels such as 38, 50, 64 and 22. In this instance, the enclosed reaction vessels are arranged to ensure the contact between the catalyst super-critical CO₂ with methanol and/or ethanol and beef fat transferred into said reaction vessels. The lateral connection tubes such as 26 and 69 are arranged to transfer L-CO₂ and methanol and/or ethanol simultaneously into the upper zone of reaction conduits via lateral conduit 26 and into lower zone of reaction conduits by lateral conduit 69. In this way, beef fat is transferred at a suitable temperature via distribution port 30, lateral conduit 68 and vertical transfer connection such as 23, directly into an end of conduit such as 24 such that the single stream of beef fat is transferred along a reaction conduit such as 24 which is then sandwiched between upper and lower streams of fluid transferred via lateral conduits 26 and 69, for example. A fundamental purpose of the arrangement of conduits and reaction cavities shown in FIG. 2 is to ensure that contact is made between beef fat and said CO₂ catalyst with methanol (or ethanol). The apparatus shown in FIG. 2 comprises a series of flat parallel sided, adjacent lamina or plate assemblies arranged together (as shown in FIG. 1 in exploded view between conduit terminating end plates 4008 and 4092). Extraction tubes can be directly connected to each manifold 4088 and 5000 to extract the resultant fluid after the reaction is complete; the resultant fluid comprising bio-diesel, glycerol, methanol and/or ethanol and any other catalysts that may have been used, may then be separated into the components of bio-diesel, glycerol, methanol and other matter such as impurities.

Referring again to FIG. 2, a three dimensional view outlines the conduits formed into 4× plates or laminae when they are stacked together as shown in FIG. 1. The rectangular plates or flat sections are arranged wherein an upper plate 40 and a lower plate 46 sandwiches plates 44 and 76 there between. An outline of cavities such as conduit 36 and enclosed vessels such as 38 and 64 which connect a series of conduits to extraction ports 10, 12, 14, 16, 18, and 20 and also 62, 60, 58, 56, 54 and 52 respectively, created by assembly of the four plates, can also be seen.

Referring now to FIG. 3, the outline of all inner conduits and transfer tubes in a section comprising 3× plates with feeding ports, lateral micro conduits with perpendicular reaction tubes and enclosed reaction vessels connected to extraction manifolds is shown with arrows such as 278, 302, 316, 224, 327, 221, 212, 270, 266, 218 and 253 showing the flow and direction of each stream of fluid through each conduit segment. It should be noted that a series of solid lines shown in FIG. 3 correspond with broken lines shown in FIG. 2 wherein inlet ports 28 and 32 correspond with 228 and 240 of FIG. 3. Fat distribution manifold 234 corresponds with conduit 30 of FIG. 2; lateral conduit 26 corresponds with 226 of FIG. 3 and so on, with reaction conduit 222, for example, corresponding with reaction conduit 24 which is shown in FIG. 2.

Referring again to FIG. 3, lateral conduits 226 and 292 connect with fluid supply port 228 such that said fluid transferred under controlled pressure and temperature in the direction shown by arrow 230 through said port 228 is pressurized such that quantities substantially controlled by the cross sectional diameter of lateral conduits 226 and 292 provide an enclosed pathway for the material supplied in the direction shown by arrow 230 to flow in the direction shown by arrows such as 224 and 320 and then in the direction shown by arrows such as 293 and 317. Fluid transferred via conduit 226 in the direction shown by arrow 224 is subsequently divided equally so as to flow via perpendicular conduits such as 294 in direction shown by arrow 317. In like fashion, fluid transferred in the direction shown by arrow 236 through port 240 is divided proportionately by transfer through lateral conduits such as 238 and 244 flowing in the direction shown by arrows 235 and 242 respectively. Perpendicular transfer tubes such as 286 and 246 provide sealed pathways for fluid transfer in the direction shown by arrows 283 and 325, respectively. Blended fluid streams transferred via connection conduits such as said 286 and 289 is transferred into an upper region of reaction conduit 288 volumetrically and substantially equally. The combined mass flow of the streams transferred through perpendicular connection tubes such as 286 in the direction shown by arrow 283 is equal to the mass flow of fluid transferred via port 234 (FIG. 3).

It can therefore be readily understood that in this way, fluids and/or suspensions transferred via ports 228 and 240 in the direction shown by arrows 230 and 236 respectively, can be distributed into reaction conduits such as 245, 323, 338, 300, 314 and 322. A stream of fluid represented by arrow 232 is pumped under pressure (480 psi to about 600 psi) along port 234 and is subsequently divided into equal but separate streams of fluid traveling in the direction shown by arrow 297 which is then divided into 12 streams comprising six (6×) pairs of streams including the stream represented by arrow 298 in conduit (or reaction tube) 300 above and the stream shown by arrow 287 in conduit (or reaction tube) 288. The fluid beef fat is therefore sandwiched between a pair of layers transferred into said reaction tube such as 300 via perpendicular conduit 294 on a first side and via conduit 296 on the upper or opposite side.

The mass flow of combined fluid transferred into ports 228 and 240 may be arranged such that it corresponds to the mass flow of fluid transferred via port 234 in the direction shown by arrow 232 such that the mass flow of the upper and lower streams, for example, transferred into conduit 338 via conduit 286 in the direction shown by arrow 283 when combined with a stream transferred into the lower zone of conduit 288 via conduit 289 will flow in the direction shown by arrow 287 at a rate substantially equal to the velocity of the fat stream transferred into reaction port 338. Most preferably the velocity of upper and lower streams transferred into reaction conduits such as 245 is substantially the same as the velocity of fluid fat material transferred from port 234 and lateral tube 297. It can be seen in FIG. 3 that the profile of each reaction conduit such as 245 changes as it approaches the extraction manifold such as 258. In fact, the width at region 254 of conduit 245 is substantially increased while the depth is substantially reduced. This causes the three streams transferred into reaction conduit 245 to become flat, parallel sheet-like streams moving in direction shown by arrows such as 251, 253 and 257. In this way, the stream of beef fat material is exposed to relatively large upper and lower surface areas, thereby encouraging rapid reactions.

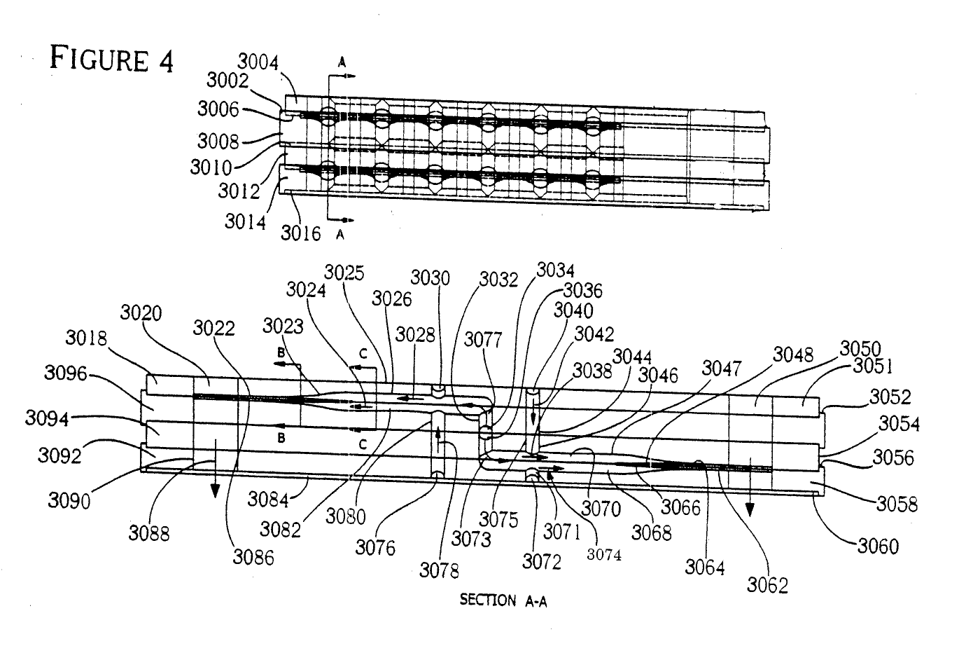

Referring now to FIG. 4, a series of cross sections through a selected section of 4× laminae or plates 3004, 3008, 3012 and 3014 are assembled together to provide an exemplary side view of the multiple laminae of the apparatus shown in FIG. 1. Ridges (e.g., 3002) in plate 3008 are located around the perimeter of both the upper and lower sides and with similar plate 3014 also having ridges, thereby providing a registration for the alternately stacked plates of 3004 and 3012 to accurately locate relative to adjacent plates 3008 and 3014. In this way, recesses such as 3070 and 3068 in adjacent plates 3054 and 3058 (which correspond to plates 3012 and 3014, respectively), provided in the surface of each plate and which are intended to be aligned correspondingly, can be aligned by locating plate 3054 against the ridges of plate 3058 and plate 3096 (which corresponds to plate 3008), respectively. In this way the conduits passing through the entire stack of plates such as 3050 and 3020 are easily aligned and lateral conduits such as 3082 and 3070 formed from depressions provided in adjacent plates are readily aligned when the plates are assembled together. Cross section “A-A” passes through lateral and vertical conduits as shown in section “A-A”.

The purpose of the arrangement shown in connection with FIGS. 1 through 5 is to enable the exposure of triglyceride molecules to methanol or ethanol with the appropriate catalyst such as L-CO₂ in the most rapid way possible. It is a purpose of this arrangement to sandwich a layer of triglycerides blended with L-CO₂ between two layers on opposite sides comprising methanol and/or ethanol and any other suitable catalyst such as sodium hydroxide if necessary. A blend of L-CO₂ and triglycerides is transferred from conduit 3034 to conduit 3082 and 3073 via vertically disposed connection tube 3032. The blend enters conduit 3082 at 3077 and similarly fluid enters conduit 3068 at 3073. Arrows show the direction of flow and the sandwiching fluid comprising a blend of methanol and/or ethanol can be transferred into conduit 3068 via vertical conduit 3042 from one side and via conduit 3071 on the alternate side. The combined three layers then transfer through a blended section at 3048 and 3066 at which point the profile of the circular cross section of a fluid in conduit 3068 changes as it travels through the areas shown as 3048 and 3066 where the fluid is fanned out as it conforms to the change in conduit profile at 3064 and 3062. The reactive fluid is then transferred into conduit 3050. In a similar fashion, fluids are transferred into conduit 3026 in the direction shown by arrows 3028 and 3024 and from there through profile changing segment 3023 and into the widened and flattened segment 3022. Referring now to sections “B-B” and “C-C” as shown in FIG. 5 firstly, it can be seen in section “C-C” that the triglyceride fluid 3202 is penetrated by oval beads 3214 and 3204. Referring now to section “B-B” the profile of the triglycerides 3102 and ethanol and/or methanol materials has been divided to provide maximum exposure such that layer 3102 is sandwiched and in close proximity to the fluids shown as 3100 and 3104. Section “B-B” of FIG. 5 shows an enlarged view of the reaction enclosure as described in connection with the earlier figures. In this way, maximum exposure between the triglycerides and ethanol and/or methanol is provided thereby rapidly producing bio-diesel and glycerol by ensuring a more complete reaction.

With appropriate quality control measures in place, the assured consistency of materials produced via the micro equipment and methods herein described provide tightened and more accurate tolerances to the respective reactions and subsequently more consistent production rates where reaction time is measured in seconds as opposed to hours for the current macro bio-diesel production technology commonly used.

Referring again to FIG. 3, in a preferred embodiment, warmed, liquid, filtered beef fat, can also be blended directly with methanol and/or ethanol and then transferred via conduit 234 in the direction shown by arrow 232 and into the ends of reaction transfer conduit such as 288. Therefore, controlled quantities of feed stock materials useful for production of bio-diesel by way of chemical reaction enhanced by suitable catalysts are directed by transfer through micro conduits directly into reaction tubes, within which solid catalysts can be fixed to the walls, designed to create close and thorough contact of the materials and the alteration of reaction tubes profiled wherein the diameter is reduced in the vertical plane and increased in the horizontal plane in blended gradual profile change wherein at the entry end of reaction conduit such as 3047 in section “A-A” is a circular profile (FIG. 4), as can be seen in section “C-C” (FIG. 5).

Referring again to FIG. 4, a fluid transferred through conduit 3032 is divided between two opposing connection tubes 3075 and 3077. Opposing recesses 3034 and 3036 in plates 3096 and 3094 create an enclosed conduit when the adjacent plates are in contact. Alternate plates are arranged to mate with each adjacent plate. Ridges such as 3052, 3002 and 3056 follow a path around the perimeter of the female plates. As can be seen, male plates such as 3051 (which corresponds to plate 3004) and 3094 penetrate the female plates when in contact such that conduits such as 3050 and 3020 are created. Male plate 3054 with adjacent female plates 3096 and 3092 provide a reaction tube 3047 connected at a first end to connection tube 3075 and at a second end to vessel sections 3062 and 3064. The circular cross sectioned reaction tube 3047 connects via a tapered region 3048 and 3066 to low profile vessel sections 3064 and 3062 in such a way that fluid transferred in the direction shown by arrow 3042 through conduit 3044 contacts fluid transferred through connection tube 3075 intimately. Correspondingly, fluid transferred through conduit 3071 into reaction tube 3047 also contacts fluid transferred via connection tube 3075 on the alternate side of fluid flowing in direction shown by arrow 3074 and collectively three separate streams of fluid combine within reaction tube 3047 and are transferred in the direction shown by arrows 3038 and 3074 through upper and lower tube segments 3070 and 3068 comprising reaction tube 3047 through tapering zones 3048 and 3066 and into low profile vessels 3064 and 3062.

Section “A-A” shows a lateral cross section of four assembled and engaging plates 3018, 3096, 3094 and 3092 and the pathway created by the assembly of said plates. In this assembly, a first fluid is transferred via tube 3032 into reaction tubes 3026 and 3047, where a second stream of fluid transferred via conduit 3030 and a third fluid transferred via conduit 3076 in the direction shown by arrow 3078 sandwiches said first fluid stream transferred via conduit 3030. Said first, second and third fluids subsequently combine in a single stream which is transferred collectively in the direction shown by arrows 3028 and 3024 via tapering section 3023 and into low profile sections 3022 and 3086. Section “A-A” also shows a second reaction tube 3047 wherein a first fluid transferred via conduit 3032 in the direction shown by arrow 3073 is subsequently sandwiched between a fourth fluid stream transferred via conduit 3044 in the direction shown by arrow 3042 and a fifth fluid stream transferred via connection conduit 3071. The combined stream of first, fourth and fifth fluids is transferred in the direction shown by arrows 3038 and 3074 through tapering sections 3048 and 3066 and into low profile sections 3064 and 3062.

Section “C-C” in FIG. 5 shows a cross section of reaction tube 3206 containing a combined stream of said first fluid 3202 sandwiched between said second fluid 3204 and said third fluid 3214. Section “C-C” has been illustrated for the purpose of showing the intimate contact of male plate 3208 and female plate 3212 in direct compressed and close contact along interface 3200 wherein reaction tube 3206 is thereby facilitated which enables said first fluid 3202 to be in close and intimate contact with said second fluid 3204 and said third fluid 3214. The elliptical profile of said second fluid 3204 and said third fluid 3214 are both transformed, after transfer via tapering section 3023 as shown in section “A-A” in FIG. 4, into sheet profiled layers 3114 and 3110 shown in section “B-B” in FIG. 5 sandwiching said first stream 3112.

Referring again to section “B-B” in FIG. 5, a pair of plates 3098 and 3108 are shown in intimate contact along interface 3102. This figure shows the profile of vessel 3022 in section “A-A” in FIG. 4 with said first stream 3112 sandwiched between said second stream 3114 and said third stream 3110. Section “B-B” indicates how said first, second and third fluid streams 3112, 3114 and 3110, respectively, are in close contact such that the reaction time between said first, second and third streams can be reduced.

It can be seen, therefore, that first, second and third fluid streams transferred via conduits 3036, 3030 and 3076 in section “A-A” are combined in such a way to enable reduced reaction time by altering the combined stream profile of said first, second and third fluids as shown in section “B-B” as layers 3112, 3114 and 3110, respectively. The close proximity of said three streams is facilitated by combining said first, second and third streams into a circular section conduit 3206, as shown in section “C-C”, which is then transformed into a low profile section as shown in section “B-B”, facilitating the combining of fluids which may repel each other due to a physical property, but which nevertheless, can be encouraged to react by altering the combined stream profile 3104 as shown in section “B-B”.

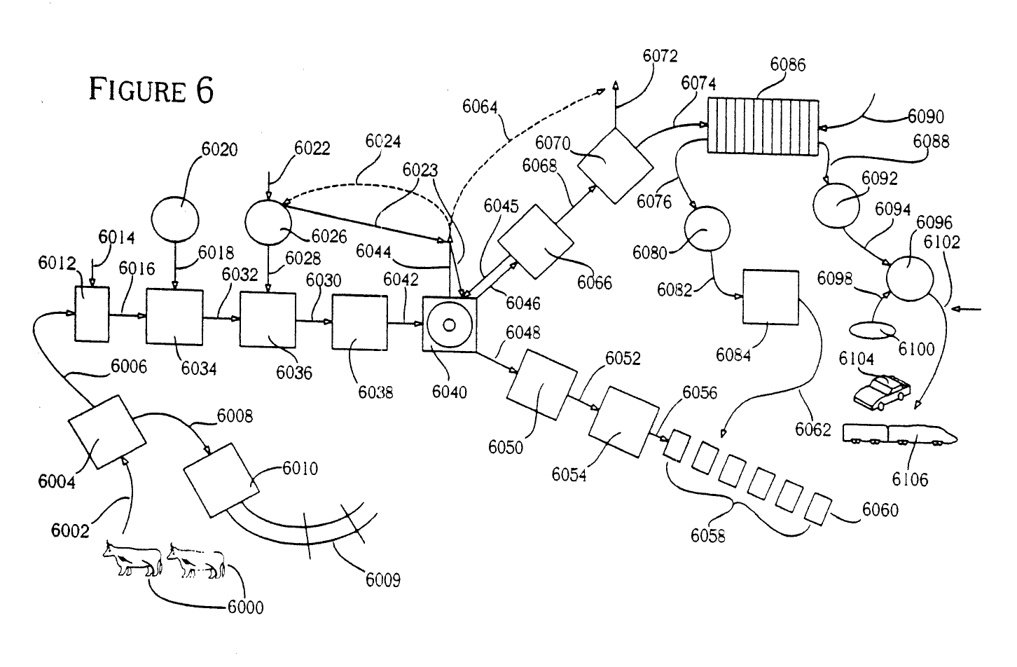

Referring now to FIG. 6, a view of the entire process is shown by way of diagrammatic representation line drawings. Cattle at 6000 enter the slaughterhouse 6004 along path 6002 and data downloaded from RFID tags which have previously been either embedded in the animals' neck muscles or any other method known in the art. Immediately following slaughter and evisceration, the carcasses are graded in factory represented by square line drawing 6004. After removal or harvesting from animal carcasses low value fat is transferred via 6008 to processing plant 6010 where either electric power or liquid fuels can be efficiently converted from this by-product. After slaughtering and chilling the animal carcasses, they are transferred via 6006 to processing plant 6012 where the animals are graded and stored. After quartering the animal and downloading information about the animal to RFID tags, special apparatus such as transponders can be arranged to check outgoing beef quarters which are transferred to the adjacent building 6034 where animals are de-boned and sliced to produce retail package cuts of beef and the remaining trim or boneless beef for ground beef production. Some packages are shipped out of 6034 in the opposite direction of arrow 6018, but the majority of packages are transferred in the direction of arrow 6032. Approximately 40% of the weight of boneless beef received in 6012 is transferred into an adjacent room 6036 for the purpose of grinding boneless beef. Liquid and gaseous CO₂ is transferred via 6028 from pressure vessel and storage tank 6026. The boneless beef is treated with a CO₂ snow and can be packaged in barrier chubs and stored in area 6038 after transfer from the factory area 6036 along 6030. While ground beef can be packaged in chubs, at this point most likely the boneless beef transferred into area 6036 will be graded and grouped into approximately one ton palletized quantities which are typically treated with CO₂ snow. Any chub production would be from the high lean grades such as 85% lean through 94% lean. Boneless beef streams comprise typically grade groupings of 75% VL (75% lean beef) or 65% VL and 50% VL. Lower grade described as 30's, comprise the remaining fat stream with any quantities up to 30% lean and perhaps 40%. These remaining palletized streams are transferred into separation enclosures via 6042. In this area, all boneless beef is ground and automatically separated into streams of any quantity ordered by customers such as 85% lean ground beef, all of which may be packaged in barrier chubs or, alternatively, case ready retail packages. The process of separation employs quantities of CO₂ which can be sourced from tank 6026 via conduit 6023 and returned after use for recycling via conduits 6044 and 6024. Packages shown as 6058 have been packaged in regions 6050 and 6054. The fat stream removed in area 6040 is then transferred to area 6066. The stream of white fatty adipose tissue is centrifuged and all proteins removed are returned to area 6040 in the direction shown by arrow 6045 and is then included in ground beef production, all of which is transferred in the direction shown by arrow 6048. After removal of solids from the fat stream at 6066, the beef fat which is now in a warm fluid condition is filtered prior to transfer in the direction shown by arrow 6068 to 6070, where it is combined with a suitable mixture and controlled quantity of liquid CO₂ under appropriate pressure which is then transferred in the direction shown by arrow 6074 to 6086. 6086 is representative of apparatus shown in FIGS. 1 through 5, 7 and 9 through 10. Bio-diesel and glycerol are produced in this way and glycerol is transferred in the direction shown by arrow 6076 to storage area 6080 where the viscous liquid glycerol is refined and transferred to customers at 6084 in the direction shown by arrow 6082. Bio-diesel transferred in the direction shown by arrow 6088 and stored at 6092 can be filtered and further refined using the method described below. Refined bio-diesel is transferred via 6094 to processing area 6096 where fossil fuel diesel transferred from 6100 in the direction shown by arrow 6098 is blended with said bio-diesel to produce a range of bio-diesel and fossil fuel diesel blends such as B2 and B20. B2 represents a blend of diesel wherein 2% bio-diesel has been added. B20 represents diesel fuel containing 20% bio-diesel and 80% fossil fuel diesel. These finished fuels are transferred in the direction shown by arrow 6102 for use as fuel in automobiles, or any engine such as trains, electric generators, and the like.

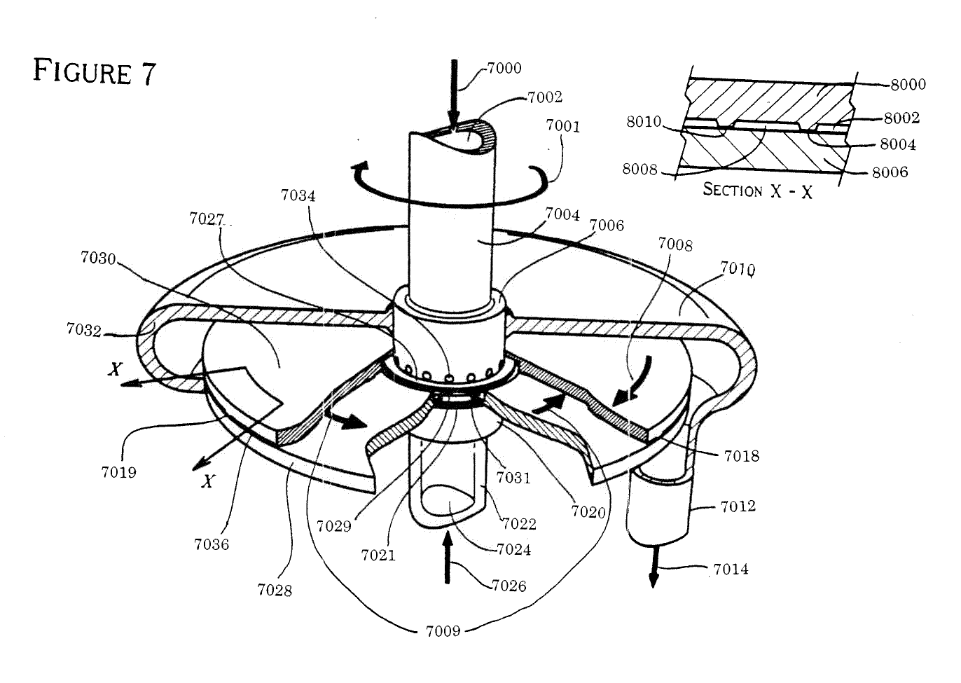

Referring now to FIG. 7, yet another preferred embodiment is shown by way of a diagrammatic representation of a pair of spinning discs traveling in opposite directions. Housing 7010 encloses a pair of machined matched discs 7030 and 7028. The purpose of this apparatus is for production of bio-diesel and glycerol from, most preferably, animal fats derived from unwanted beef fat. In order to produce bio-diesel and glycerol, the reactive ingredients are desirably blended together at a suitable temperature such as 70° F. or between about 65° F. and about 130° F.

A disc 7030 manufactured from a suitable material such as 316 stainless steel which has been machined and surface treated, is shown. Disc 7030 is fixed rigidly to centrally located perpendicular first drive shaft 7004 via boss and bearing housing 7006. A second disc 7028 is shown adjacent to and parallel with disc 7030. Disc 7028 is mounted to a boss 7020 with suitable bearing means and to a second drive shaft 7022. Drive shaft 7004 desirably comprises a heavy wall tube manufactured from a suitable material such as stainless steel and is provided with conduit 7002 thereby allowing fluid to be transferred there through, for example, in the direction shown by arrow 7000. Conduit 7002 can be provided with drive means such as a variable speed electric drive that can rotate shaft 7004 in the direction shown by arrow 7001. A series of apertures such as 7034 extending along a path parallel with machined disc 7030 and around the circumference of boss 7006 communicate directly with conduit 7002. Shaft 7022 can be provided with a driving motor capable of driving in either direction and at any selected speed. Conduit 7024 communicates with a series of apertures such as 7029 wherein said apertures follow a path parallel and adjacent to said first series of apertures 7034. A diffusing disc 7027 extends around the perimeter of apertures 7034 and also apertures 7029. It should be noted that a diffusion disc such as 7027 could be manufactured with a barrier splitting said disc 7027 along a plane parallel with rotating discs 7030 and 7028. The assembled apparatus shown in FIG. 7 is also provided with an enclosing cover 7010 which encloses a space around and close to parallel discs 7030 and 7028. Enclosure 7010 is provided with a conduit 7012 which can transfer fluids there through in the direction shown by arrow 7014. The purpose of the apparatus shown in FIG. 7 is to provide a reliable and efficient means of manufacturing bio-diesel. A fat stream at a suitable pressure such as between 400 and 600 psi (pounds per square inch) can be transferred in the direction shown by arrow 7000 into conduit 7002. The catalysts (e.g., sodium hydroxide and/or L-CO₂, with water as required) and methanol and/or ethanol can be transferred under pressure corresponding with the pressure of triglyceride fats transferred through conduit 7002 and in the range of 400 to 600 psi. Parallel discs 7030 and 7028 are arranged in close proximity and with space of between 100 and 200 microns, and an example of providing the space is shown in section “X-X” where radial ridges 8010 and 8004 which correspond with ridges 7019 and 7018 provide spaces such as 8008 and 8002. In this way, triglyceride fats transferred through radial holes such as 7034 and then through upper section through diffuser 7027 can pass between said discs 7030 and 7028. Correspondingly, fluids transferred in the direction shown by arrow 7026 through conduit 7024 in shaft 7022 and then through annular apertures such as 7029 and then through the lower segment of diffuser 7027 can also transfer into space between rotating discs 7030 and 7028 at a controlled rate. Fluids transferred through conduit 7002 can, in this way, travel through a radial space parallel with disc 7030 and toward the perimeter thereof. Fluids pumped at a controlled rate in the direction shown by arrow 7026 also communicate with conduit 7024 and radial apertures such as 7029 and into the space between discs 7030 and 7028. Therefore, in this way fluids transferred through conduit 7002 contact fluids transferred through conduit 7024 between said discs 7030 and 7028 first coming into contact after passing through diffuser ring 7027 and into said annular space between discs 7030 and 7028. Therefore, in this way fluids transferred through 7002 come into intimate contact with fluids transferred through 7026 in the annular space between said discs 7030 and 7028. Disc 7030 can be driven in the direction shown by arrow 7008 at a speed of, for example, between 5000 and 15000 rpm while disc 7028 can be driven in the direction shown by arrows 7009 and in the opposite direction of arrow 7008. Fluids passing between said rotating discs 7030 and 7028 are thereby exposed to very high shear. Furthermore, fluids become mixed continuously at high speed and are unable to stratify or escape the high shear and severe blending conditions between said discs 7030 and 7028. Conduit 7012 can be connected directly with a suitable valve and pumping arrangement with flow regulators maintaining a suitable pressure in the space between rotating discs 7030 and 7028 and enclosure 7010. Fluids therefore are able to react during the time they are enclosed between said rotating discs and before transferring into the enclosed space within enclosure 7010 through radial slots such as 7036. Said discs 7030 and 7028 can be held together by mechanical pressure with contact restricted by ridges such as 7019 and 7018. The apparatus shown in FIG. 7 can be arranged with multiple pairs of discs corresponding with multiple parallel rows of apertures such as 7034 and 7029. In this way, manifolds may be arranged, for example, within boss 7006 and 7020 such that streams of materials and fluids can be transferred between each pair of plates such that a quantity of fluid transferred through conduit 7002 will be transferred into the space between each pair of discs and correspondingly fluids transferred through conduit 7024 can also be transferred between each set of rotating discs in a similar fashion to the description herein such that fluids from conduit 7002 come into intimate contact with fluids transferred through conduit 7024 and are then subjected to high shear as the fluids are pumped through the space between each set of plates.

Referring again to FIG. 7 and the disclosure above, the apparatus shown can be used to produce bio-diesel and any other fluid derived from ingredients that may or may not mix well together. The purpose of this apparatus is to ensure thorough mixing of fluids in proportionate quantities as required or desired by the reactions to facilitate the bringing together of all components needed for a particular reaction on a “micro” scale.

Referring now to FIG. 8, an organic chemical reaction is shown with triglyceride and methanol molecules shown in proportionate quantities to the left of the arrow pointing toward the resultant organic chemicals of the reaction, one fatty ester molecule and one glycerol molecule. As can be seen for each triglyceride molecule, three molecules of methanol are required to produce a single fatty ester molecule and a single glycerol molecule.

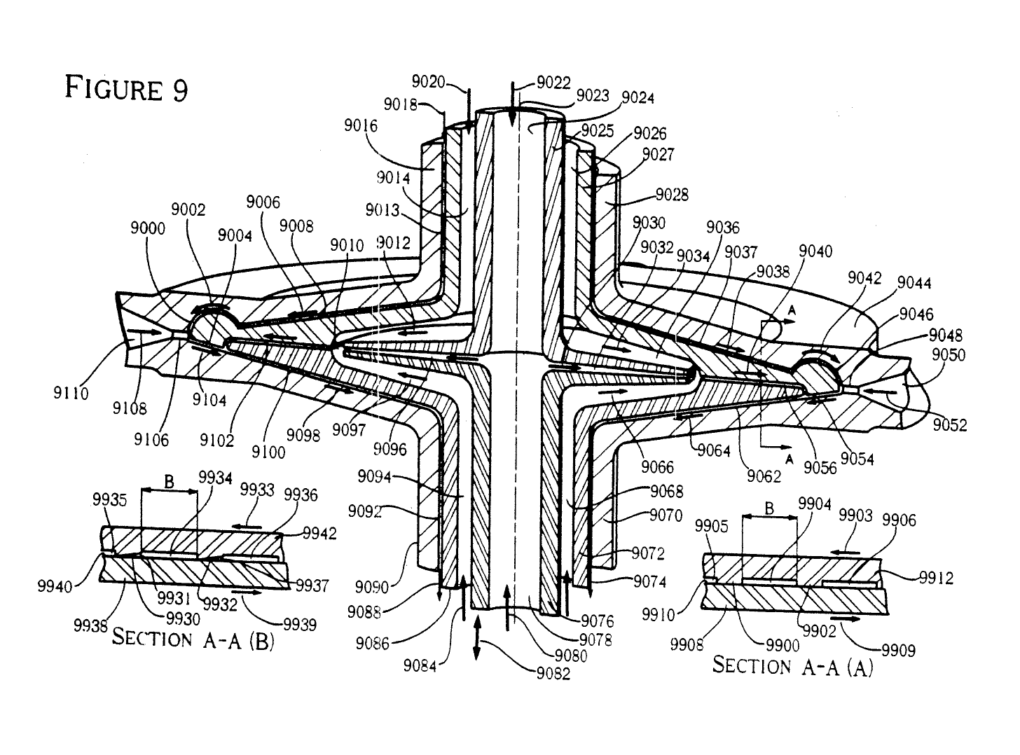

Referring now to FIG. 9, an apparatus is shown in a three dimensional cross sectional view. The apparatus shown in FIG. 9 is intended for use in the production of fatty esters or bio-diesel and glycerol from raw materials comprising, for example, clean, filtered beef fat or tallow elevated in temperatures such that its flow characteristics are as needed to efficiently facilitate blending with methanol and/or ethanol and a catalyst such as sodium hydroxide, potassium hydroxide, but most preferably, CO₂ which may be used either as a sub-critical or in super-critical fluid phase. The apparatus comprises a series of concentric members wherein a conduit 9024 with liquid transferred there through in the direction shown by arrow 9022 is fitted with a flange section having a substantially flat face. In diametrically opposing position, a similar member comprising conduit wall 9076 with conduit 9078 is arranged to retain flange portion with center line 9023 common to both members 9076 and 9025. Conduits (not shown) are sealingly attached to each member 9025 and 9076 such that fluid at a selected temperature and pressure can be transferred in the direction shown by arrows 9022 and 9080. Enclosing members 9025 and 9076, a pair of members 9027 and 9086 with spaces 9014, 9094, 9068 and 9036 are concentrically arranged such that the inner surface profile of said members 9027 and 9076, when in operating position as shown in FIG. 9, generally follows the outer profile of members 9025 and 9076. Enclosing members 9027 and 9086, outer housing members 9028 and 9016 are arranged with spaces 9008, 9092, 9062, 9037 and 9013, such that there is no contact between the outer members 9028 and 9090 with inner members 9086 and 9027. The apparatus in FIG. 9 generally comprises three pairs of opposing members, each pair retaining pressurized fluids. Cross section “A-A” (A) shows a cross sectional profile of the contacting surfaces of members 9027 and 9072. As can be seen, member 9027 is arranged with radially extending ridges 9900 and 9902 with spaces 9904 and 9906, for example, so that the contacting ridges such as 9900 and 9902 press against the parallel inner flat surface 9910 of member 9908. Member 9908 of section “A-A” corresponds with member 9072, and member 9912 in section “A-A” corresponds with member 9027. Each pair of members such as 9025 and 9076 are separately and independently mounted to driving means such that, for example, member 9076 can be activated so as to apply pressure in the direction shown by arrow 9080 at which time, member 9025 can be held in rigid disposition. Similarly, member 9908 can be compressed toward member 9912, thereby applying a controlled pressure to the face of ridges such as 9900 and 9901. Applying pressure in this way can cause generation of heat through friction when member such as 9908 is rotated in the direction shown by arrow 9909, either when member 9912 is held stationary or, alternatively, member 9912 can be rotated in the direction shown by arrow 9903, by any suitable independent driving means. Each pair of members such as 9025 and 9076 or 9072 and 9027 can be rotated by variable speed driving means such that any suitable speed of rotation can be arranged. In operation, manifolds are provided to transfer pressurized fluids to each space between the concentric members, for example, members 9025 and 9027 and members 9027 and 9028 can be arranged to transfer pressurized fluid in spaces 9026, 9037, 9014, 9013, and/or 9024 in the direction shown by arrows 9022, 9020 and 9018. Additionally, fluids can be transferred from any suitable source via a suitable manifold arranged to transfer said fluid into conduit 9078 in the direction shown by arrow 9080 or in the direction shown by arrow 9084 into space 9094 and, in doing so, provide streams of fluid that will follow the internal profile of member 9086 and the outer profile of member 9076 through spaces 9094 and 9068 and then in the direction shown by arrows 9097 and 9066. Similarly, fluid transferred into conduits 9024 and 9078 in the direction shown by arrows 9022 and 9080, respectively, will follow the internal contour of conduits 9078 and 9024 in the direction shown by arrows 9080 and 9022, respectively. Said fluid transferred into the central conduits 9024 and 9078 can transfer through spaces 9096 and 9032 radially extending outward and away from center line 9023 and into space such as 9010. Fluids transferred via 9014 in the direction shown by arrow 9020 and into space 9094 in the direction shown by arrow 9084 can contact with other fluids transferred in the direction shown by, for example, arrows 9012, 9034, 9066 and 9097 and can reach the annular space 9010 immediately prior to transfer through annular space such as 9102 in a radially outward extending direction, as shown by arrow 9040. In this way, fluids such as beef fat having been suitably refined and transferred through radial spaces 9096 and 9032 in the direction shown by, for example, arrow 9030 can be encapsulated or sandwiched within a fluid, such as super-critical CO₂, transferred through, for example, spaces 9014 and 9094 in the direction shown by arrows 9012 and 9034. Fluids transferred through conduits and spaces such as 9094, 9014, 9026, 9036 and 9068 can be heated as a consequence of friction between the faces enclosing spaces such as 9096 and 9032 by rotating members 9076 and 9025 in opposing directions and/or by applying pressure simultaneously in the direction shown by arrows 9080 and 9022, whereby heat is generated in direct proportion to the energy spent in compressing the members together while rotating. In this way, sub-critical liquid CO₂ transferred through a space such as 9014 can be heated to, for example, above 100° F., therefore, causing super-critical phase to occur. Fluid transferred in the direction shown by arrow 9018 through space 9013, or alternatively through conduit 9110 in the direction shown by arrow 9108 and through space 9050 in the direction shown by arrow 9052 can be arranged to reduce the combined temperature of fluid transferred from annular space 9010 through 9056 in the direction shown by arrow 9040. The profile of each member can be arranged to create restriction or provide more space for fluids being transferred under suitable pressure through each annular space. Temperature can be controlled by either developing heat through friction as described above or the temperature of any fluid can be reduced when combined with a fluid of a lower temperature transferred in controlled mass flow via space 9050 in the direction shown by arrow 9052. Fluids transferred through space 9013 in the direction shown by arrows 9006 and 9002 may be combined with fluids transferred through conduit 9106 and conduit 9048 prior to contacting fluids transferred through spaces 9102 and 9056 in the direction shown by arrows 9012 and 9040, respectively, at a confluence with fluids transferred through 9004 in the direction shown by arrow 9014. With the apparatus as shown in FIG. 9, all fluids may be transferred, ultimately into conduits 9078, 9094, 9014, 9013 and 9106 and combined in layers which can be thoroughly blended by the rotating of members such as 9086 or 9090 in opposing relative directions. In each case where opposing faces provide space through which fluids can be transferred, the respective members can be arranged to apply pressure and to generate heat which can be precisely controlled so as to suit a particular reaction. In this instance, such a method of generating a controlled quantity of heat can be used to convert sub-critical liquid CO₂ to a super-critical phase, thereby inducing the aggressive solvent property of super-critical CO₂ which can then be blended with, for example, beef or plant oils such that when such mixture is added to a controlled quantity of methanol and/or ethanol, bio-diesel and glycerol can be produced. The apparatus shown in FIG. 9 indicates several conduit spaces which can provide for blending of up to six or more fluids together. However, in the production of bio-diesel, the fluids typically include a proportionately controlled blend of liquid CO₂ and beef fat maintained at a temperature such that both are in fluid state, which is then combined with liquid methanol and/or ethanol. Catalyst sodium hydroxide or similar optionally can be eliminated.

The apparatus shown in FIG. 9 is arranged such that the distance between the opposing faces, each side of spaces 9032 and 9097 will most preferably be on the order of 0.004″ or 100 microns and similarly, spaces at 9056 and 9102 defined by parallel surfaces of faces such as 9912 and 9908 shown in section “A-A” (A) can also be arranged at a distance of 100 microns between the faces. The distance between radial ridges such as 9902 and 9900 can be as much as 1.0″, however, a preferred dimension for distance B as shown in section “A-A” (A) will be 200 microns. Ridges such as 9900 and 9902 as shown in section “A-A” (A) allow fluid to be transferred through spaces 9904 and 9906. When member 9912 is rotated in a direction such as shown by arrow 9903, opposite to the direction of member 9908 shown by arrow 9909, fluid transferred through spaces 9904 and 9906 can be thoroughly blended while controlled heat generated by friction at the ridges such as 9900 and 9902 can be advantageous to the reaction of fluids in said spaces. For example, beef fat or oil is not miscible with methanol and, in fact, the fluids of methanol and beef fat tend to separate, therefore, providing a difficult condition for reaction between methanol and beef fat. However, by proportionately controlling a mixture comprising measured quantities of fluid beef fat, methanol and CO₂, the rotating action of member 9912 against member 9908, results in the transfer of fluid in 9906 between the face of ridge 9902 and member 9908 and thereby subjecting this fluid to extreme pressure. Also, fluid in space 9904 is transferred via the minute space between 9900 and the flat face of member 9908. Fluid transferred between said spaces is similar in volume across the face of all ridges such as 9900 and 9902 and this action can provide an aggressive mixing action for fluids being transferred through spaces such as 9904 and 9906. Furthermore, long carbon chain molecules such as triglycerides can be stretched or contorted while transferring through the narrow spaces between a ridge such as 9900 and a face, such as 9908.

Referring again to FIG. 9 and, in particular, section “A-A” (B), ridges 9932 and 9930 are shown with a wedge profile such that gaps 9931 and 9937 enables fluid transfer via space 9934 and 9936 to be forced into said gaps 9937 and 9931 and compressed such that any large molecules such as triglycerides can be stretched or, alternatively, any fluids transferred through spaces such as 9934 and 9936 are thoroughly blended when rotating member 9942 is rotated in the opposite direction to the arrow 9934 against the stationary member 9938 or, alternatively, when member 9938 rotates in the direction opposite to the direction shown by arrow 9939. Section “A-A” (B) shows the alternative profile ridges, however, other aspects are similar to those of section “A-A” (A). More particularly, spaces 9934 and 9936 are exemplary and representative of all such spaces provide along the radial band following a path wherein member 9072 and member 9027 are held together under pressure and where contact between the two members occurs only at the ridges such as 9930 and 9932. In this way, high pressure, such as 10,000 lbs per square, inch can be applied to the points of contact between said member 9942 and member 9938 of section “A-A” (B).

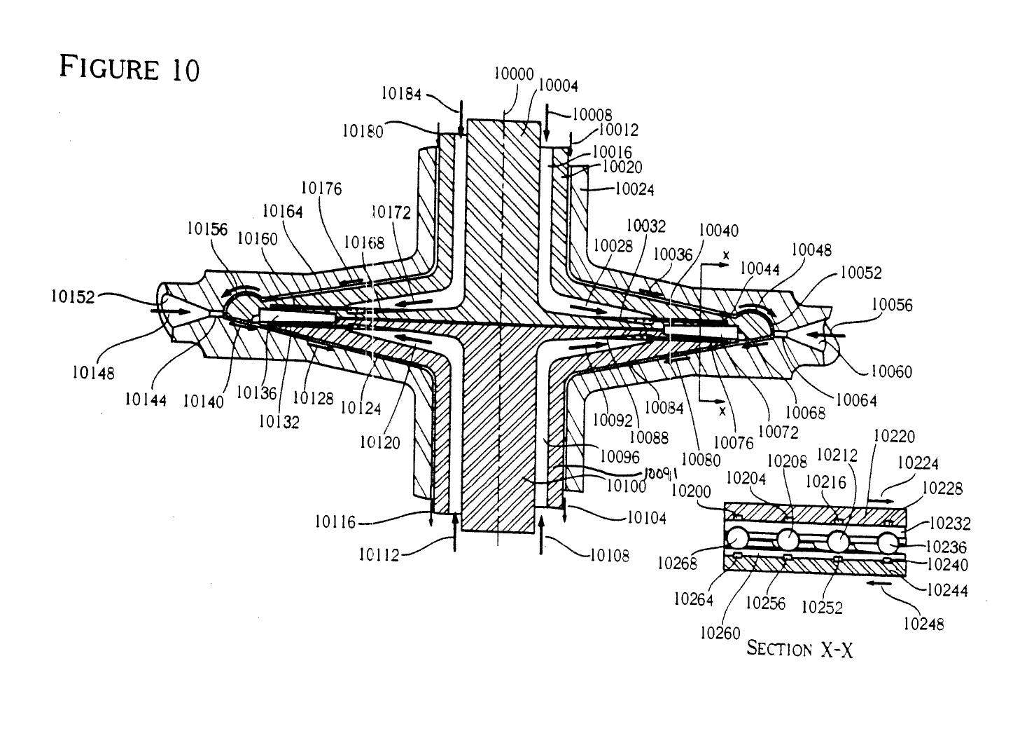

Referring now to FIG. 10, a cross section through an apparatus similar to the apparatus disclosed above in association with FIG. 9 is shown. Outer housing at 10024 is provided to enclose a series of rotating members including 10020, 10004 and 10100. Each member such as 10024 is connected directly to a rotating means and conduit which enables the pressurized temperature controlled transfer of fluids in the direction shown by arrows 10180 and 10012 and through channel provided by spaces such as 10164 and 10040. Fluids transferred between members 10020 and 10024 follow a conduit outwardly in the direction shown by arrows 10176 and 10036. The plan shows a circular profile to the apparatus shown in FIG. 10 and the members 10004 and 10100 can be rotated at any selected speed and in opposite directions such that fluid transferred into conduit such as 10016 are transferred through the conduit 10016 and in the direction shown by arrows 10184, 10008, 10172 and 10028. Member 10100 is fixed rigidly to a driving means and is located in apposite disposition to member 10004 and can be rotated about a common center line 10000 which is common with member 10004. Cross section “X-X” shows the end view of a segment shown by line X-X and tapered rollers 10268, 10208, 10212 and 10236 are held captive in recesses of member 10220 with radial channels 10200, 10204, 10216 and 10228, radiating from center line 10000 which connects directly with channel 10016. In the upper member 10228, which corresponds with member 10020 in opposing member 10244 which corresponds with member 10091, members 10020 and 10091 rotate in opposite directions as shown by arrows 10224, member 10244 and 10248 in section “X-X”. Member 10244, which corresponds with rotating member 10091 is shown with radiating channels 10264, 10256, 10252 and 10240 radiating from center line 10000 and communicating directly with channel 10096. Rollers 10268, 10208, 10212 and 10236, shown in section “X-X” are arranged to be retained by recesses in member 10220 and held against opposing flat inner surface of member 10244. Therefore, as member 10220 rotates in the direction shown by arrow 10224, member 10244 may be held stationary or rotate in the direction shown by arrow 10248. Under these conditions, rollers such as 10268 and 10208 are rotated in a clockwise direction when viewed as shown in section “X-X”. It can be seen that fluid transferred through conduit 10016 in the direction shown by arrows 10184, 10008, 10172 and 10028 after passing through micro conduits such as 10044 and 10160, the channel shown as 10232 in section “X-X” will enable the direct transfer of said fluid transferred through conduit 10016 and into space around tapered rollers such as 10268 and 10208. Conversely, fluid transferred through conduit 10096 in the direction shown by arrows 10112, 10108, 10092 and 10120 will communicate via micro channels 10076 and 10132 and as shown in section “X-X”. After transfer through micro conduit such as 10264 and 10256 in member 10244, the fluid having been transferred most preferably under selected pressure and at a selected temperature via conduit 10096 will contact tapered rollers such as 10268, 10208 and 10236 in section “X-X”. It can be seen, therefore, that when a selected first fluid such as methanol is transferred through, for example, conduit 10096 in the direction shown by arrow 10108 and a second beef tallow fluid is transferred via conduit 10016 in the direction shown by arrows 10008 and 10028, both first and second fluids can meet and contact around the space between rollers such as 10268 and 10208 and the recesses in member 10220 retaining said tapered rollers under temperature and pressure control, when the second fluid has rate of mass flow proportionate to said first fluid transferred through conduit 10096. The two fluids will make contact with each other as rollers 10268 and 10236, for example, are rotated in a clockwise direction when viewed according to section “X-X”. Furthermore, pressure can be applied to both members 10020 and 10091 in the direction shown by arrows 10184 and 10012 and controlled pressure can also be applied to member 10091. The only point of contact between members 10091 and 10020 is via said tapered rollers such as 10268 and 10236. Said pressure applied via said roller such as 10268 can be controlled so as to provide a most efficient process such that when said first and second fluids are in contact in space around roller such as 10268, pressure applied to members 10020 and 10091 is applied to the blended first and second fluids also. The rate of mass flow of said first and second fluids, the pressure applied via members 10020 and 10091 and the rotational speed of member 10020, corresponding with member 10220, in the direction shown by arrow 10224 against member 10091, corresponding with member 10244, rotating in the direction shown by arrow 10248 can be controlled at any suitable speed, but most preferably, on the order of 1,000-2,000 rpm or, alternatively, up to 10,000 rpm or more or less. FIG. 10 shows that fluid can also be transferred in the direction shown by arrows 10180, 10012, 10176 and 10036 continuing in the direction shown by arrows 10156 and 10048 via channel 10052 so as to blend with fluid transferred through conduit 10060 in the direction shown by arrow 10056 and conduit 10152 in the direction shown by arrow 10148. Fluid transferred in this way can combine and collectively travel in the direction shown by arrow such as 10068 and 10140 so as to then blend with combined fluids transferred via conduits 10016 and 10096 in conduit 10124 and 10084. Finally, the combined fluids transferred into the apparatus shown in FIG. 10 can be transferred via conduit 10124 and 10084 in the direction shown by arrows 10116 and 10104.

Referring again to FIG. 10, most preferably the apparatus can be used to produce bio-diesel at a high rate of production by ensuring the correct and thorough blending of immiscible fluids, such as methanol and fluid beef tallow or oil. The method described in association with FIG. 10 provides a series of radially located rollers such as shown in section “X-X”, rollers 10268, 10208, 10212 and 10236. Any convenient quantity of radially located rollers similar to those shown in section “X-X” can be provided around the full annular band created by the contact point of all rollers rotating in recesses such as shown by rollers 10268, 10208, 10212 and 10236 in section “X-X”. All rollers can be fitted and retained by recesses in a first member such as 10220 so as to rotate and roll across the annular band that said rollers can contact. Said first member 10220 may rotate in the direction shown by arrow 10224 in opposing disposition to said second member 10244 rotating in the direction shown by arrow 10248 and said members 10020 and 10091 may be held under pressure so as to clamp said rollers such as 10268 and 10236 shown in section “X-X”. Fluid transferred via radial micro conduit such as 10200 and 10264 can be blended thoroughly by the action of said rollers such as 10268 in the confinement of the space between the respective components including member 10220 and opposing member 10244 which apply pressure to fluids as they are blended by transfer through the respective micro conduits such as 10268 in member 10244 and via micro conduit such as 10204 in member 10220 of section “X-X”. Furthermore, it should be noted that when large molecules of organic compounds such as triglycerides are provided under fluid pressure in the manner described herein above then subjected to confinement between hardened tapered rollers such as 10268 in section “X-X”, the molecules can be stretched and when in a stretched condition are more likely to react with other elements or compounds such as methanol or ethanol.

The apparatus described in association with FIG. 10 (and FIG. 9) provides a series of annular conduits through which miscible or immiscible fluids can be transferred for the purpose of blending together in a confined space. When blending such immiscible or miscible fluids in a confined space and subjecting the fluids to an intense mixing action, the desired reaction can occur rapidly and within the confinement of the space provided. After transferring into the confined space around rollers such as 10268 and 10236, etcetera and being subjected to intense blending action facilitated by the confined rollers, a more complete reaction between the fluid compounds can occur. Referring again to FIG. 10, it should be noted that the fluids transferred through the annular passageway shown are provided under controlled pressure at a selected temperature and each annular conduit is separated from adjacent annular conduits by manifold attachments provided with suitable seals and bearings. Pressure provided via members such as 10004 and 10100 rotating in the opposing direction shown by arrows such as 10008 and 10108 can be provided by hydraulic piston and suitable retaining sleeve. The hydraulic liquid of the piston may be the fluid being transferred. A suitable screw and thread arrangement can be provided such that when a selected pressure has been facilitated, a lock nut can be arranged to fix the desired pressure for the duration of the production run.

Referring again to FIG. 10, the preferred embodiment is shown in the apparatus and according to the disclosure above provides a means of producing bio-diesel and glycerol from, for example, beef fat and methanol using liquid phase or super critical CO₂ as the catalyst, enabling reaction between the triglycerides of the beef fat and methanol and/or ethanol. The reaction occurring is as shown in FIG. 8 wherein three methanol molecules and a single triglyceride molecule react to produce a mixture of fatty esters and a single glycerol molecule. The volume of bio-diesel (fatty esters) produced is approximately 10 times the volume of glycerol produced when manufactured with apparatus similar to that shown in FIG. 10 (or FIG. 9) and, in particular, when CO₂ is used as catalyst. The requirement of washing with large quantities of water to separate any sodium hydroxide or potassium hydroxide, catalyst may be eliminated. More particularly, when using the apparatus described in FIG. 10, the production process is much more rapid, does not require large quantities of water and any remaining CO₂ catalyst evaporates when exposed to ambient conditions.

In another preferred embodiment, bio-diesel and glycerol produced in the manner described in association with FIG. 10 can be processed so as to crystallize glycerol and fatty esters by lowering the temperature to below the freezing point of these two products. More particularly, a mixture of glycerol fatty esters (bio-diesel) and L-CO₂ can be transferred through a similar aperture or nozzle into an expansion chamber wherein the pressure drop across the nozzle is sufficient to freeze the glycerol and bio-diesel, thereby causing it to crystallize while maintaining the majority of the CO₂ in liquid phase. For example, a pressure drop from 500 psia down to 350 psia will reduce the temperature well below the crystallizing point of bio-diesel and glycerol. A resultant blend of crystallized glycerol, crystallized bio-diesel and L-CO₂ can then be transferred to a suitable separation apparatus. The blend of crystallized glycerol and bio-diesel with L-CO₂ can be separated by centrifuging in an enclosed pressurized decanter style centrifuge. The density of glycerol is 78 lbs per cu.ft., while the density of bio-diesel is 58 lbs per cu.ft. The density of L-CO₂ can be adjusted such that bio-diesel will float and glycerol will sink under normal gravitational conditions. However, when transferred in continuous stream through a centrifuge separator, the solid, crystallized glycerol can be readily separated from the L-CO₂ and crystallized bio-diesel. Subsequently, the L-CO₂ can be separated from the crystallized bio-diesel. Any moisture present will be evaporated during the process and the crystallized bio-diesel can then be heated until liquid phase is reached. In this way, glycerol of high quality without impurities can be manufactured when using CO₂ in either liquid or dense vapor phase as the separating medium and catalyst.

Referring to FIGS. 1 through 5 and FIGS. 7 and 9 through 10, two sets of apparatus for the production of bio-diesel are disclosed. The purpose of this apparatus is to provide effective and efficient manufacture of bio-diesel and glycerol with equipment of substantially reduced physical dimensions when compared to typical bio-diesel plants currently in use.

Following the production of bio-diesel and glycerol in a single continuous stream emanating from conduit 7012 in FIG. 7 and manifolds 7000 and 4088 in FIG. 1, it may be desirable to separate bio-diesel from the mixture of components in a single stream and to ensure that it can be cleaned and then isolated in storage vessels prior to use as a fuel; also glycerol can be separated from the stream and isolated in separate storage.

The following lists properties of the preferred components involved in the production of bio-diesel and glycerol according to the above disclosures;

Specific Gravity Chart

| | Matter (and | | Approx- | | |
|---|---|---|---|---|---|
| | Abbreviated | Process | imate | Solid or | |
| | Identifying | Temperature | Melting | Liquid | Density |
| Item | Mark) | Range | Point | (@31° F.) | Lbs/cu′ |
| 1 | Glycerol | >29°->90° F. | 18° C. | Solid | 78 |
| 2 | Methanol | >29°->90° F. | −65° C. | Liquid | 49 |
| 3 | Liquid Carbon | >29°->90° F. | −57° C. | Liquid | 58 |
| | Dioxide | | | | |
| | (L-CO₂) | | | | |
| 4 | Water (H₂O) | >29°->90° F. | 0° C. | Solid | 62 |
| 5 | Bio-diesel | >29°->90° F. | 20° C. | Solid | 58 |
| 6 | Tallow | >29°->90° F. | | Solid | 55 |
| | (Beef fat) | | | | |

The Specific Gravity chart above lists six preferred components associated with the reaction to produce bio-diesel as disclosed herein. The approximate melting point of each component is also shown with the temperature range of the reaction. The reaction as proposed between methanol and triglycerides produces glycerol and bio-diesel in a single stream and it is therefore desirable to separate the components of the resultant stream prior to using the products after manufacture. A decanter style centrifuge has the capacity to separate crystallized glycerol from the bio-diesel by using the correct style of decanter centrifuge which should be enclosed and able to withstand a pressure of approximately 500 psi. The blend may be continuously transferred into the decanter style centrifuge. Crystallized glycerol with a specific density of 78 lbs/cu.ft. is the most dense of the six materials listed in the above table (assuming all six components are present; it should be noted that the quantity of the methanol component can be substantially reduced when L-CO₂ is present and used as the catalyst and carrier or medium and the micro apparatus utilizing reaction conduits of approximate dimension 100 microns×200 microns or less or more), therefore methanol would be the first material to separate and settle against the inner surface of the rotating bowl of the centrifuge. The entire stream of fluids can be transferred through a restriction in the conduit through which it is flowing such that the controlled pressure drop across the restriction is sufficient to cause a temperature drop as required to solidify any component contained within the stream, as desired. For example, assuming that the temperature of the stream is about 75-80° F. and at a pressure of about 1,100 psi immediately after the reactions are complete, the stream could be transferred through a small orifice of suitable size such as 0.125″ diameter to about 0.25″ diameter thereby causing a substantial reduction of temperature; and when the temperature drops to <18° C., all glycerol will solidify and the smaller the orifice is, the smaller will be the crystals of glycerol. Transferring said stream through a small aperture, thereby facilitating a significant pressure drop, into a vessel of sufficient volume (or comparable conduit), controlled at about 500 psi will ensure smaller crystals are formed as the selected pressure drop enables crystals of the selected component to solidify. The pressure drop could, for example, be arranged to occur as the stream is transferred into a decanter style or other suitable centrifuge. Bio-diesel is also crystallized at the lower end of the proposed temperature range and with a specific gravity of 58 lbs/cu.ft. can float on L-CO₂ when the pressure in the centrifuge is elevated to 600 psi. Therefore a procedure can be followed whereby in a first pass through a decanter style centrifuge, pressure can be held at an elevated pressure, say of approximately 600 psi and 34° F. when only the glycerol and water of the above six components will separate out and fall away from the center of the centrifuge and be held against the inner wall of the centrifuge thereby enabling separation with a standard screw conveyor. Glycerol can then be washed with an adequate quantity of water sprayed into the outer beach region of a decanter style centrifuge through which the glycerol is transferred. In this way, glycerol can be thoroughly washed without requiring copious quantities of water. The remaining fluid transferred from the first centrifuge pass, which may contain methanol, L-CO₂ and bio-diesel, can be transferred to a second or third decanter style centrifuge operating at an internal pressure of approximately 600 psi and a temperature of 30° F. In this case, bio-diesel will be the heaviest, or that component with the highest specific gravity, and will therefore settle against the inner wall of the centrifuge bowl, enabling removal by the conveyor (Archimedes screw). Methanol will accumulate as the inner most layer in the concentric layers of the operating decanter style centrifuge. A dam or weir at an end of the centrifuge can be provided to enable the removal of liquid methanol which has a very low freezing point and will therefore remain liquid during this process at 30° F. Finally, L-CO₂ can be boiled off to atmosphere, or alternatively filtered and recycled.

Referring again the Specific Gravity Chart, a list of six components representing components that may be present during the production of bio-diesel is provided. However, the process is not limited to just these six components. Solid catalysts such as silica may be used in a bio-diesel production process, for example, and other catalysts are also appropriate for use as long as they can either be fixed to the inner surface of the process reaction tubes (see above) or alternatively provided as a suspension or solution blended with the stream of components.

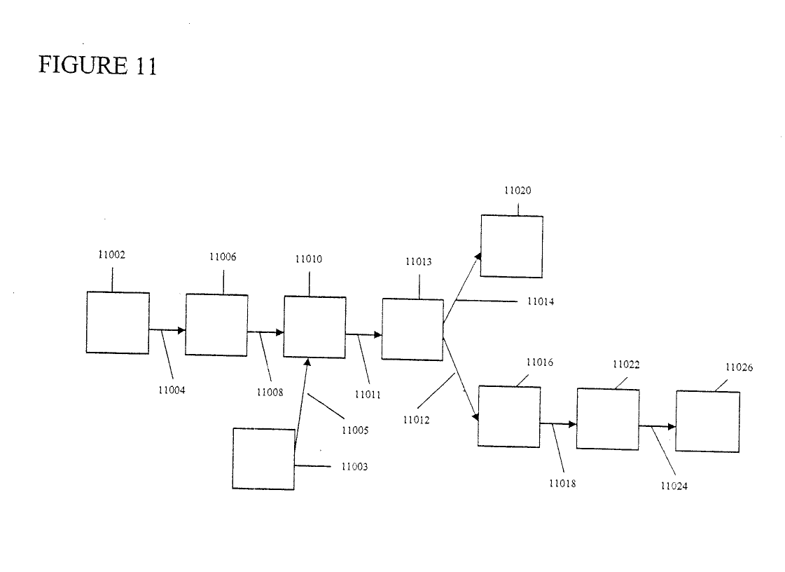

Referring now to FIG. 11, a diagram comprising a series of rectangles with connective arrows shows steps in a production configuration that can be arranged to produce bio-diesel and other components of a chemical reaction that uses plant matter as a source of triglycerides to produce bio-diesel. Rectangle 11002 represents an apparatus capable of grinding, chopping or generally cutting a stream of plant matter into very small pieces which can then be pulverized in equipment 11006 wherein a transfer conduit 11004 can be arranged to automatically transfer the processed plant matter to pulverizer 11006. Conduit 11008 transfers the pulverized plant matter to a pumping station 11010 wherein a selected quantity of the pulverized plant material is compressed into a conduit by way of a reciprocating piston with connecting rod attached to a crank shaft (not shown in detail) wherein said crank shaft revolves at a suitable speed, thereby providing a reciprocating piston action such that said piston compresses a quantity of pulverized plant matter into said conduit followed by the opening of a space in said conduit, allowing a subsequent quantity of pulverized plant matter to be transferred therein which is then also compressed against the plant material having been compressed in the immediate earlier compression stroke of said reciprocating piston.

In this way, plant matter can be progressively transferred from apparatus 11002 through said conduit 11004 in a tightly compacted condition, then pulverized in enclosed apparatus 11006 and pumped through conduit 11008 and combined with L-CO₂ transferred from storage source vessel 11003 through conduit 11005. The blended stream of plant matter and L-CO₂ is then transferred via high pressure pump 11010 at a controlled temperature above 87.87° F. and higher than the critical pressure 1070 psia. Said first conduit inhibits the escape of L-CO₂ from said second conduit due to the tightly compacted condition of the plant matter sealing any pathway there through. In this way, pulverized plant matter can be mixed with L-CO₂ to provide a mix of L-CO₂ and pulverized plant matter in a continuous stream transferred under a selected pressure and temperature. Said homogenous blend of pulverized plant matter and L-CO₂ may also be transferred from said second conduit into a third conduit via a check valve. Said blend of pulverized plant matter and L-CO₂ can then be transferred through said third conduit and heated to a temperature by way of one or more band heaters provided in tight contact around said third conduit, thereby also elevating the temperature of the combined blend of L-CO₂ and pulverized plant matter to a pressure and temperature above the minimum threshold for super-critical CO₂, thereby causing a phase change of said L-CO₂ to super-critical condition. In this way, plant matter having been pulverized and then blended with L-CO₂ can be compressed together with super-critical phase CO₂. In this way, any fats or oils contained in the pulverized plant matter can be separated in a miscible blend with super-critical CO₂.

Referring again to FIG. 11, compressor 11010 elevates the pressure of said blended stream of L-CO₂ and pulverized plant matter such that L-CO₂ changes phase to a stream of super-critical phase which can then be transferred through high pressure conduit 11011 to centrifuge 11013 where liquefied oil can be removed from the pulverized plant matter and transferred through a high pressure conduit 11011 to centrifuge 11013.

Centrifuge 11013 shall most preferably be a vertically disposed decanter style and built in such a manner that the pressure exerted internally by the expanding force exerted by super-critical CO₂ will be safely contained. Centrifuge 11013 can be provided with at least two extraction ports through which a first stream extraction port oil separated from said pulverized plant matter can be extracted in the direction shown by arrow 11012 and a second stream of pulverized plant matter extracted is transferred via a second conduit 11014 to storage container 11020. Oil transferred via conduit 11012 is blended with L-CO₂ and a quantity of methanol equal to about 5% of the total volume, and the combined materials are blended and heated in vessel 11016. Blended materials comprising super-critical phase CO₂ and methanol are blended with oil extracted from said pulverized plant matter and the temperature and pressure of the combined blend of materials are elevated to approximately 250° F. and 150 atmospheres.

Referring again to FIG. 11, in another preferred embodiment, the method of grinding and, most preferably, liquidizing any suitable plant matter, such as rapeseed involves the entire plant in the process, but in any event, those parts of the plant which yield the highest ratio of oil. The liquidized plant matter is then pressurized to a selected pressure such as above the lowest temperature at which CO₂ can exist in super-critical phase. Most specifically, the liquidized plant matter can be blended with super-critical phase CO₂ and thoroughly agitated until all oil formerly contained within plant cells has been extracted and separated from the source cellular repository. The most suitable pressure at which CO₂ will exist in super-critical phase or above critical pressure is 1069.96 psia and the minimum temperature at which CO₂ will exist in critical phase is 87.87° F. Therefore, in order to provide the aggressive solvent properties required to extract oil from plant matter, super-critical phase CO₂, being an aggressive solvent, is most suitable for this purpose. In another preferred embodiment, plant matter may be shredded and processed by transferring through a grinder such as a Moyno® grinder pump and, in particular, with the employment of a Moyno® annihilator and/or a Moyno® pipeliner which has been designed and developed for industrial applications in food processing such as the processing of vegetable and fruit waste, paper and stock waste, poultry waste, and corn kernel. Additionally, it may be beneficial to install more than one grinder pump in series along the same conduit. Bailed plant matter can be stuffed into a Moyno® pump of any suitable design using, for example, the Moyno® 2000HS system such that the plant matter, whether dry or still wet after recent harvest, can be handled with such equipment as is manufactured by Moyno® and then pumped continuously through Moyno® grinders. Most importantly, plant matter can be processed and handled most readily when in a fluid condition; therefore, after processing the plant matter with the use of Moyno® grinders as described above, L-CO₂ can be blended with the finely ground plant matter to form a single continuous stream of plant matter and L-CO₂. The continuous stream can then be processed further by way of transferring through a suitable centrifuge as designed and manufactured by American Beef Processing, LLC of Clackamas, Oreg. Equipment can be obtained from either Moyno® or American Beef Processing, LLC at 15501 SE Piazza Avenue, Clackamas, Oreg. 97015.

A stream of processed plant matter and L-CO₂ can be transferred through a centrifuge so as to separate all solid matter in a single stream extracted from the fat and the extracted oil will be removed during the centrifugal process at suitable rate, such as 30,000 pounds per hour.

An alternative method of separation to the centrifugal method proposed herein can be by way of a stratification separation column wherein the stream of L-CO₂, oil and remaining solid plant matter is transferred in an enclosed conduit to a suitable column, most preferably manufactured from either stainless steel such as 316 or carbon steel, and allowed to stratify therein. The stratification process enables each component of the processed stream such as plant oil (corn oil) or any oil extracted from any suitable source, but most preferably, in this instance, plant matter, to be separated into layers of stratified material. For example, oil having a specific gravity of approximately 55 lbs/cu.ft. can stratify above water having a specific gravity of 62.4 lbs/cu.ft. Solid plant matter and, in particular, the cellulose cell walls having a different specific gravity, will also stratify. L-CO₂ has a specific gravity of approximately 29 lbs/cu.ft. when retained in super-critical phase and, therefore, being the lightest component separated at the stratification pressure vessel, will stratify and float to the upper levels in the column.

Recently an improved method of producing bio-diesel from plant matter has evolved incorporating the use of super-critical methanol under treatment conditions of 350° C. and 43 MPa, however, while the reaction time has been reduced, it remains difficult to apply due to the high cost of pressure vessels large enough to contain the reacting materials for the duration of the reaction time. Furthermore, a temperature of 350° C. is too high to the extent that plant matter will decompose readily at this temperature and contaminants will be produced in quantities too large to prevent the deleterious consequences of decomposing plant matter at 350° C. The method disclosed herein employs the benefit of lowering the temperature at which a blend of methanol with sufficient CO₂ will enter super-critical phase.

Additionally, the extraction of oil from plants can be achieved as described herein in association with FIG. 11 wherein super-critical phase CO₂ is blended with a stream of pulverized plant matter. The aggressive solvent properties of super-critical phase CO₂ rapidly extracts any fat (triglycerides). Subsequent to the extraction of triglycerides, a measured quantity of methanol and/or ethanol can be added to the continuous stream of plant matter and CO₂ such that by elevating the pressure and temperature to approximately 250° C. and 2300 psig, bio-diesel can be produced in a continuous stream by transesterification of triglycerides extracted from the plant matter. Subsequently, the components of the continuous stream can be separated in a suitable enclosed and pressurized centrifuge.

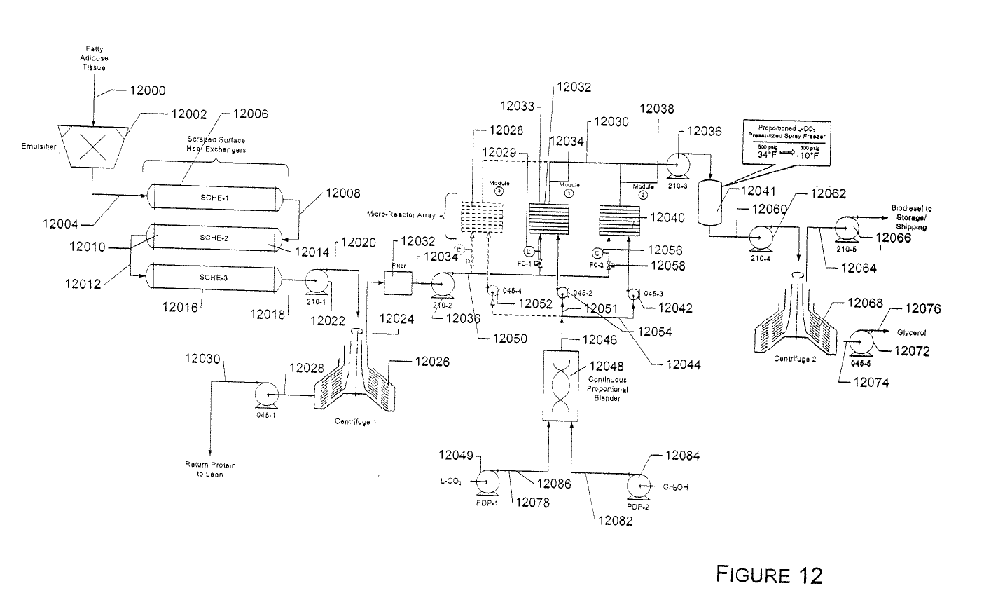

Referring now to FIG. 12, a diagram showing a preferred method of bio-diesel and glycerol production is shown in plan view. The diagram shown in FIG. 12 shown as illustrative only and has not been drawn to scale. However, the apparatus for this preferred method of producing bio-diesel is shown in a convenient manner for the purpose of explanation. A stream of fatty adipose tissue sourced from beef cattle slaughtered, eviscerated, dressed and chilled for the purpose of harvesting beef for human consumption is transferred via conduit 12000 and into emulsifier 12002. The stream of fatty adipose tissue is harvested simultaneously with the production of a second stream of lean boneless beef using equipment manufactured by American Beef Processing, 15501 SE Piazza Avenue, Clackamas, Oreg. The first and second streams of boneless beef are produced in production quantities typically on the order of approximately 50,000 lbs/hr for the lean stream and 35,000 lbs/hr for the fatty adipose tissue stream. The ratio of the first and second streams can vary according to the lean content of the primary stream fed into the separation equipment. However, most commonly, 50's or, in other words, a supply of boneless beef comprising 50% lean and approximately 50% fat is most commonly used. The special apparatus manufactured by American Beef Processing can be arranged to process more or less than 100,000 lbs/hr and typically the mass flow ratio of the fatty adipose tissue stream will be on the order of 40,000 lbs/hr. Protein content within the fatty adipose tissue and lean beef attached to the fatty adipose tissue can be removed by the method described hereunder. The equipment operates according to the following description.

Conduit 12000 is a fully enclosed conduit through which boneless beef can be transferred under pressure and conduit 12000 is attached to the inlet manifold of an emulsifier such as is manufactured by Cozzini, Inc. Other manufacturers are also capable of building this equipment, however, the equipment manufactured by Cozzini, Inc. has been found to be reliable and capable of processing adequate quantities in a given production period. Furthermore, the fatty adipose tissue transferred under pressure via conduit 12000 can be transferred safely, reliably and substantially without leaking such that the stream of fatty adipose tissue, when transferred into emulsifier 12002 at a rate of approximately 40,000 lbs/hr can be reliably emulsified, such that the maximum particle size does not exceed the maximum size that can be reliably and consistently processed by the equipment described in association with FIG. 12. The input stream 12000 to emulsifier 12002 is desirably supplied at a mass flow rate of approximately 30,000 lbs/hr or more or less, but at such a quantity as to enable the emulsification. After emulsification, the stream of emulsified fatty adipose tissue is transferred via an enclosed conduit 12004 to enclosed scraped surface heat exchanger 12006. Scraped surface heat exchanger 12006 can be manufactured by Waukesha Cherry-Burrell in Wisconsin and the arrangement of heat exchangers shown in FIG. 12 includes three horizontally disposed conduits connected at each end to, firstly an inlet and secondly an outlet, such that scraped surface heat exchanger 12006 is connected directly to second scraped surface heat exchanger 12012 via conduit 12008 and scraped surface heat exchanger 12010 is connected directly to third scraped surface heat exchanger 12016 via conduit 12012. Said flow of emulsified fatty adipose tissue may be transferred via conduit 12004 into a bank of scraped surface heat exchangers in a stream of substantially consistent rate of flow, and after said stream of fatty adipose tissue has been processed therein, the temperature of the fatty adipose tissue extracted from said bank of scraped surface heat exchanger via conduit 12018 may be approximately 115° F. The bank of heat exchangers may comprise any suitable number therein, however, in the arrangement as shown in FIG. 12, a total of three separate horizontally disposed scraped surface heat exchangers are shown. The temperature of said stream of processed fatty adipose tissue transferred via conduit 12018 to pump 12022 should be greater than 108° F. and less than 120° F. It is a purpose of the apparatus shown in association with FIG. 12 to separate substantially all protein and solid matter such as collagen connective tissue and/or cartilinageous bone from a stream of clear, warm, filtered beef fat. The heated stream transferred into pump 12022 is transferred under pressure via conduit 12020 to first centrifuge 12026. First centrifuge 12026 separates the stream of warm fatty adipose tissue into two components comprising a first stream of clear, warm, filtered beef fat via conduit 12021 and into filter 12032. Said second stream of solids separated by means of first centrifuge 12026 comprises all solid matter derived from the stream of heated fatty adipose tissue and is transferred via conduit 12028 directly to positive displacement pump 12029 and into enclosed conduit 12030 under suitable pressure. A stream of protein, connective tissue, cartilinageous bone and other semi-solid matter pumped under pressure via positive displacement pump 12029 is returned to apparatus not shown in association with FIG. 12, however, said stream of solids is blended with lean beef separated from said stream of 50's referred to above prior to retail packaging or further processing into beef patties or the like.

The stream of beef fat transferred via enclosed conduit 12021 and filtered in filter 12032 prior to transfer into pump 12036 via conduit 12034 is then blended with proportional quantities of methanol and/or ethanol and a proportionate quantity of L-CO₂. The blend comprising beef fat, methanol and/or ethanol and L-CO₂ in suitable proportions is maintained at a selected temperature and pressure of up to 250° C. and 2250 psi for a period of time sufficient to facilitate the reaction between the three materials, such that bio-diesel or a mixture of fatty esters and glycerol is produced from the reaction shown in FIG. 8.

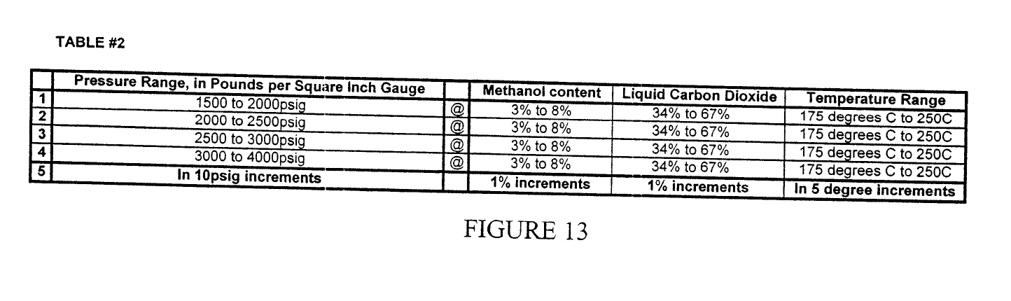

Methanol is provided from a source and transferred by positive displacement pump 12084 via conduit 12082 in the direction shown by the arrow and a relatively proportionate quantity of L-CO₂ is pumped by positive displacement pump 12049 in the direction shown by the arrow via conduit 12078. A blender which may be a continuous static blender 12048 or any other suitable type of blender is provided as shown. Generally, the apparatus shown in FIG. 12 is arranged to provide three streams of liquid matter each provided under suitable pressure such that the combined stream will react according to the organic chemical reaction shown in FIG. 8. It is desirable in order to maximize efficiency of the reaction that the liquid materials be provided in measured quantities, precisely controlled, in a continuous stream. Temperature and pressure should be maintained at optimum values in order to achieve the most efficient production rate available. The combined stream may be transferred via one or more reactors each optionally containing an appropriate solid catalyst, if necessary, which should line the walls of each micro channel which are arranged in a series of parallel micro conduits within micro reactor arrays 12040, 12032 or 12027. The blended stream of liquid materials pumped via positive displacement pumps 12036, 12049 and 12084 should be maintained at an optimum temperature and pressure of 250° C. or more or less and 2250 psig or more or less or at any other suitable temperature and pressure that will facilitate the most rapid and effective reaction between the three materials comprising the combined stream. Table #2 (FIG. 13) shows a range of temperatures and pressures that can be maintained to achieve maximum efficiency of the reaction which is similar to the reaction shown in FIG. 8. The stream of liquid comprising glycerol and a mixture of fatty esters transferred via conduit 12030 to pump 12036 comprises residual methanol and CO₂ which is desirably extracted and disposed of by exhausting to atmosphere or, alternatively, recycling. However, in order to achieve maximum efficiencies, super-critical phase of methanol and super-critical phase of L-CO₂ is desirable during the reaction process. Pump 12036 controls the stream pressure such that it is continuously transferred into vessel 12041 via an orifice with a variable aperture size. The entire stream of fluids can be transferred via the aperture which is located within vessel 12041 such that a drop in stream pressure occurs as the fluids pass through said aperture. The cross sectional area of the aperture opening can be controlled and configured such that a pressure and substantial temperature drop occurs, causing certain fluids to crystallize. For example, the controlled pressure drop can be arranged such that glycerol is crystallized, thereby solidifying the fluids such that CO₂ will become gaseous and can be extracted from vessel 12041 at a rate and mass flow-controlled extraction enabling a precise control of pressure within said vessel 12041. CO₂ extracted in this way can then be compressed and transferred through a suitable heat exchanger such that L-CO₂ can be transferred directly into a storage vessel and retained for subsequent recycling. The remaining fluids are transferred via conduit 12060 and positive displacement pump 12062 into centrifuge 12068 where glycerol having a specific gravity on the order of 78 pounds per cubic foot is readily extracted when suspended in L-CO₂ pressurized to approximately 500 psi and retained at approximately 32° F. L-CO₂ can be extracted and recycled and glycerol simultaneously extracted and transferred to a storage vessel and retained for subsequent use. Said glycerol formed in this manner is a purest form of glycerol devoid of contaminates such as sodium hydroxide which cannot be removed entirely when manufactured by way of the commonly used or conventional bio-diesel production process using sodium hydroxide as a catalyst. Bio-diesel produced in this way comprises the majority of the fluids transferred into centrifuge 12068 and thereby extracted from the stream of fluids. Bio-diesel produced in this way is also of the purest kind and washing with water is not required since there are no contaminates such as residual sodium hydroxide. Bio-diesel is transferred into suitable storage vessel, but most preferably, into road and/or rail tankers for immediate shipping to customers. Bio-diesel produced in this manner is the most suitable for use as an additive in fossil fuel diesel. Federal legislation requires that sulfur be extracted from all fossil fuels, however, without lubricants that are presently unavailable, fossil fuel diesel will be unsuitable for use in reciprocating diesel engines. It is therefore considered probable that bio-diesel produced in accordance with the methods disclosed herein, shall be used as an additive in the amount of approximately 2% of the total mass weight of the fossil fuels produced subsequent to September 2006. 2% bio-diesel produced in the manner herein disclosed provides sufficient lubricity when added to the fossil fuels processed in accordance with legislation.

The three components, CO₂, methanol (and/or ethanol) and triglycerides, will most preferably be transferred by positive displacement metering pumps sized suitably according to the relative proportions of each stream component. Such metering pumps are manufactured by, for example, Bran+Leubbe. Such metering pumps can be sized and manufactured according to requirements thereby enabling precise measuring and metering of the liquids under selective pressure and temperature. The pumps manufactured by Bran+Leubbe are available from 611 Sugar Creek Boulevard, Delavan, Mich. 53115.

A typical reaction period for bio-diesel produced via the relatively low pressure method employing sodium hydroxide as the catalyst may be as much as 24 hours or more or less. A typical period is greater than 7 hours, however, the reaction time for production of bio-diesel as per the reaction shown in FIG. 8 may be as short as 20 seconds, 30 seconds or 3 minutes or more or less, depending upon the ratio of CO₂ and methanol and/or ethanol maintained in super-critical phase for the duration of the reaction phase. Typically, the quantity of methanol and/or ethanol blended with sodium hydroxide in a reaction designed to address the failure of triglycerides to contact and react with methanol in the most common method employed by industry presently is two times the actual quantity of methanol actually required for the reaction. However, in all cases, separation of the resultant blend of liquid materials requires either use of a centrifuge or a separation tower or stratification column in which materials separate according to their specific gravity. Clearly, by minimizing the quantity of methanol that exceeds the amount required for a complete reaction is desirable and such minimum quantity can be achieved.

Referring again to FIG. 12, an apparatus arranged to maximize efficiency is shown for materials that comprise L-CO₂ catalyst. Methanol in liquid form can exist at ambient pressure of 14.7 psi and a temperature of 20° C., however, at this temperature and pressure, CO₂ is a gas. In order to provide super-critical phase methanol and CO₂, the pressure of the combined materials must exceed 2000 psi when the temperature is maintained at above 250° C. However, the ratio of methanol to CO₂ is less than 50% methanol and more than 50% CO₂, wherein the CO₂ must be a saturated vapor and/or in super-critical phase at 250° C.

FIGS. 14 and 15 show two views of an enclosed, pressurized hydrocyclone which can be constructed to provide yet another aspect of the present invention wherein the apparatus can be devised for continuously separating lean beef, beef fat and CO2 from a fluid stream that includes all three components. The enclosed and pressurized hydrocyclone comprises a uniformly proportioned, centrally disposed enclosure having a lower segment profile similar to that of a steep inverted cone, typically having a circular profile cross section through the horizontal plane profile, an input port for accepting a fluid stream and at least three (desirably at least four) output ports for transferring the separated components (i.e., beef fat, lean beef and CO2) out of the hydrocyclone. The hydrocyclone effects a density-based separation of the solid (and liquid) components when suspended in a fluid, wherein such a fluid stream entering close to the upper end and at a tangential orientation relative to the circular cross section of the hydrocyclone body, thereby accelerating the stream as it descends through the decreasing diameter (radius) of the steep cone, forcing the heavier components toward the walls of the hydrocyclone and the lighter components toward the middle of the enclosed space within the hydrocyclone. Thus, heavier components exit the cyclone through an output port at, or toward, the bottom of the hydrocyclone cone shaped segment, while lighter components exit the hydrocyclone through output ports located at, or toward, the top of the hydrocyclone body. In some embodiments, the fluid stream is pumped into the input port of the hydrocyclone (e.g., using a suitably sized centrifugal pump), which is in communication, via a sealed connection, with a grinder, which is itself in communication, via a sealed connection, with a source of beef, such that a continuous stream of beef is ground prior to entering the input port. The ground beef is combined with pressurized CO2 to form a suspension of beef particles in the CO2. The suspension may be transferred into input port of the hydrocyclone in a controlled, continuous stream at a velocity and rate of mass flow most suited to the hydrocyclone apparatus. The source of beef is desirably, but not necessarily, any suitable quantity of 50's, 65's, or even 75's boneless beef but most preferably that grade of boneless beef that yields the most lucrative, proportional quantities of fat and lean beef derived from the selected source.

An illustrative embodiment of a hydrocyclone having four output ports and a means for separating lean beef from beef fat using the apparatus is represented in FIG. 14, which represents a three-dimensional view of the apparatus, and FIG. 15, which shows a cross-sectional view of the apparatus. As shown in these two figures, the hydrocyclone has a main body that includes an upper section 1424 having generally parallel side walls and an upper wall 1514, and a lower section 1428, 1534 having a generally conical longitudinal cross-section. The upper and lower sections may be connected by a continuous annular weld 1426. The hydrocyclone further includes at least one input port in communication with an input conduit 1436 through which a continuous stream of fluid may enter the upper section of the body of the hydrocyclone. A first output port 1434, 1530 in communication with the lower end of the lower section of the body is also provided. The first output port may be connected to the body by a continuous annular weld 1430. The hydrocyclone includes three additional output ports disposed above the upper section of the body. The second output port 1404, 1562 extends upwardly from the hydrocyclone and is disposed opposite the first output port 1432, 1530, such that the first and second output ports share a common center line. A third output port 1412, 1512 extends upwardly and outwardly from the top wall 1514 of the upper section of the body of the hydrocyclone. Finally, a fourth output port 1406, 1504 extends outwardly from the centerline of the hydrocyclone and is in communication with the body of the cyclone through a neck section 1558 connected to the upper wall 1514 of the upper section of the body.

A process for separating the beef fat, lean beef and CO2 from a fluid stream containing beef solids (e.g., boneless, ground beef) suspended in fluid CO2 may be described as follows. The suspension may be prepared by blending together the ground beef with liquid carbon dioxide pressurized at least about 480 psia (e.g., 480 psia to about 600 psia) and maintained at about 34° F. (e.g., about 32° F. to 38° F.) in proportions of approximately one part ground beef to four or five parts carbon dioxide to provide a well formed suspension of solid beef components and a liquid carbon dioxide component. The suspension is continuously pumped into input conduit 1436, 1518, as represented by arrows 1401 and 1516. Inside the body of the hydrocyclone, the denser lean beef particles tend to migrate toward the walls of the body of the cyclone, traveling in a downward direction and exiting the hydrocyclone through the first output port 1432, 1534 in the direction shown by arrows 1434 and 1534. The path of the lean beef particles is represented by arrows 1522, 1526, 1530, 1534, 1550, 1546, 1542, 1540, 1538, 1539, 1536, and 1532. The less dense beef fat particles migrate toward the center of the hydrocyclone, initially in a downward direction, before turning upward, and exiting through the third output port 1412, 1512 or the fourth output port 1406, 1504. The path of the beef fat particles is represented by arrows 1520, 1524, 1528, 1532, 1544, 1548, 1552, 1554, 1503, 1505, 1561 and 1509. The CO2, being the least dense material, exits at the top of the hydrocyclone through the second output port 1404, 1562 in the direction shown by arrow 1502. The result is a separation of the fluid into three separate streams: one comprising predominantly lean beef extracted in the direction shown by arrow 1434; one comprising predominantly beef fat extracted in the direction shown by arrow 1408; and one comprising CO2 represented by arrow 1402.

Beef oil harvested from any suitable ground boneless beef source material and separated from the components combination of the source, according to any procedure disclosed herein above, can be transferred directly to the bio-diesel production processing system.

For the purposes of this disclosure and unless otherwise specified, “a” or “an” means “one or more”. All patents, applications, references and publications cited herein are incorporated by reference in their entirety to the same extent as if they were individually incorporated by reference.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

While the preferred embodiment of the invention has been illustrated and described, it will be appreciated that various changes can be made therein without departing from the spirit and scope of the invention.

What is claimed is:

1. A method of continuously producing bio-diesel by a transesterification of animal-derived triglycerides, the method comprising reacting a first stream comprising the triglycerides with a second stream comprising ethanol, methanol, or a combination thereof in the presence of fluid CO₂ within a pressurized conduit for a period of time sufficient to produce bio-diesel and glycerol at a pressure of at least 1000 psia and a temperature of at least 80° F.

2. The method of claim 1, wherein the first stream and the second stream are combined in proportionally controlled mass flow rates within the pressurized conduit to provide a pressurized third stream, and further wherein the first stream, the second stream, or both the first and second streams comprise the fluid CO₂.

3. The method of claim 2, wherein the first stream comprises the fluid CO₂.

4. The method of claim 2, wherein the second stream comprises supercritical ethanol, supercritical methanol, supercritical CO₂, or a combination thereof.

5. The method of claim 2, wherein the second stream is divided into two sections, and further wherein the first stream is sandwiched between two sections of the second stream.

6. The method of claim 1, wherein the triglycerides are derived from beef fat.

7. The method of claim 1, wherein the conduit has an internal cross-sectional diameter of about 100-200 microns.

8. The method of claim 1, wherein the conduit has an entry end having a circular cross-sectional profile and a low profile section having an elongated cross-sectional profile.

9. The method of claim 2, wherein the first stream and the second stream flow at substantially equal velocity.

10. The method of claim 1, wherein the reaction extends for a period of no more than about 1 minute.

11. The method of claim 1, wherein the reaction extends for a period of no more than about 20 seconds.

12. The method of claim 1, wherein the reaction occurs at a temperature of about 200-350° C. and a pressure of about 2000-3000 psi.

13. The method of claim 1, wherein the ethanol or methanol is present in excess.

14. The method of claim 1, further comprising separating the bio-diesel from the glycerol.

15. The method of claim 14, wherein the step of separating the bio-diesel from the glycerol is carried out continuously in a stream transferred via an hydrocyclone.

16. The method of claim 14, wherein the step of separating the bio-diesel from the glycerol is carried out in a centrifuge.

17. The method of claim 14, further comprising the step of separating the residual fluid CO₂ from the bio-diesel to provide substantially pure, contaminant free bio-diesel.

18. The method of claim 14, further comprising filtering the separated bio-diesel.

19. The method of claim 18, further comprising blending the filtered bio-diesel with fossil fuel derived diesel.

20. The method of claim 2, wherein the mass flow of the first stream is proportional to the mass flow of the second stream.

21. An apparatus for combining fluids comprising:
(a) a first drive shaft capable of rotating, the first drive shaft defining a first central conduit in communication with one or more apertures running perpendicular to the central conduit;
(b) a first disc fixed around one end of the first drive shaft, the first disc having a planar surface and radial ridges extending along the planar surface;
(c) a second drive shaft capable of rotating, the second drive shaft defining a second central conduit in communication with one or more apertures running perpendicular to the central conduit;
(d) a second disc fixed around one end of the second drive shaft and mounted in parallel, contacting proximity with the first disc such that an annular space is formed between the first and second discs, wherein the one or more apertures of the first drive shaft and the one or more apertures of the second drive shaft open into the annular space between the first and second discs and further wherein the radial ridges of the first disc define radial slots between the planar surface of the first disc and the contacting surface of the second disc; and
(e) an enclosing cover enclosing the space around the first and second discs and defining a conduit for transferring fluids out of the enclosed space.

22. The apparatus of claim 21, wherein the radial slots have a height of less than 200 microns.

23. The apparatus of claim 21, further comprising a diffusing disc extending over the one or more apertures of the first drive shaft and the one or more apertures of the second drive shaft.

24. A method for continuously producing bio-diesel using the apparatus of claim 21, the method comprising rotating the first and second discs in opposite directions, transferring a first stream comprising triglycerides through at least one of the first or second central conduits, and transferring a second stream comprising ethanol, methanol, or a combination thereof through at least one of the first and second central conduits, whereby the streams contact and react to form bio-diesel and glycerol in the annular space between the first and second discs.

25. The method of claim 24, wherein the first stream, the second stream, or both streams further comprise liquid or supercritical CO₂, and further wherein the second stream comprises supercritical ethanol, methanol or a combination thereof.

26. An apparatus for mixing fluids comprising:
(a) an inner concentric member comprising:
(i) a first conduit wall defining a first centrally disposed conduit and a first flange having a substantially flat face disposed around the first conduit; and
(ii) a second conduit wall defining an annular second centrally disposed conduit and a second flange having a substantially flat face disposed around the second conduit, wherein the second flange is disposed in diametric opposition to the first flange, such that the first and second conduits share a common center line and an annular space is formed between the substantially flat faces of the first and second flanges;
(b) an outer concentric member concentrically enclosing the inner concentric member comprising:
(i) a third conduit wall disposed around and concentric with the first conduit wall, such that the space between the third conduit wall and the first conduit wall forms a third conduit, and a third flange having a substantially flat face disposed around the third conduit and concentric with the first flange; and
(ii) a fourth conduit wall disposed around and concentric with the second conduit wall, such that the space between the fourth conduit wall and the second conduit wall forms a fourth conduit, and a fourth flange having a substantially flat face disposed around the fourth conduit and concentric with the second flange, wherein the fourth flange is disposed in diametric opposition to the second flange, such that the third and fourth conduits share a common center line and an annular space is formed between the substantially flat faces of the third and fourth flanges; and
(c) an outer housing concentrically enclosing the outer concentric member.

27. The apparatus of claim 26, wherein the substantially flat face of the first flange, the third flange, or both, comprises radial ridges and further wherein the radial ridges define radial slots between the first flange and the second flange, between the third flange and the fourth flange, or both, and further wherein the radial slots have a height of no more than about 200 microns and a width of no more than about 200 microns.

28. A method for continuously producing bio-diesel using the apparatus of claim 26, the method comprising rotating the first and second flanges in opposite directions, rotating the third and fourth flanges in opposite directions, transferring a first stream comprising triglycerides through at least one of the first and second central conduits, and transferring a second stream comprising ethanol, methanol or a combination therefore through at least one of the third and fourth conduits, whereby the streams contact and react to form bio-diesel and glycerol in the annular space between the third and fourth flanges.

29. The method of claim 28, wherein the first stream, the second stream, or both streams further comprise fluid CO₂.

30. An apparatus for mixing fluids comprising:
(a) an inner concentric member comprising:
(i) a first shaft and a first flange having a substantially flat face disposed around the first shaft; and
(ii) a second shaft and a second flange having a substantially flat face disposed around the second shaft, wherein the second flange is disposed in diametric opposition to the first flange, such that the first and second shafts share a common center line and an annular space is formed between the substantially flat faces of the first and second flanges;
(b) an outer concentric member arranged concentrically around the inner concentric member comprising:
(i) a first conduit wall disposed around and concentric with the first shaft, such that the space between the first conduit wall and the first shaft forms a first conduit, and a third flange having a substantially flat face disposed around the first conduit and concentric with the first flange, wherein the substantially flat face defines a plurality of tapered recesses extending in a radial direction such that a cross section perpendicular to the center line of said tapered recesses defines a portion of a circle; and
(ii) a second conduit wall disposed around and concentric with the second shaft, such that the space between the second conduit wall and the second shaft forms a second conduit, and a fourth flange having a substantially flat face disposed around the second conduit and concentric with the second flange, wherein the fourth flange is disposed in diametric opposition to the third flange, such that the first and second conduits share a common center line and an annular space is formed between the substantially flat faces of the third and fourth flanges;
(iii) a plurality of tapered rollers retained in the plurality of tapered recesses defined by the third flange and held against the substantially flat face of the fourth flange, such that the centerline of each tapered roller converges at the center of the annular space between the first and second flanges; and
(c) an outer housing enclosing the outer concentric member.

31. A method for continuously producing bio-diesel using the apparatus of claim 30, the method comprising rotating the third and fourth flanges in opposite directions, transferring a first stream comprising triglycerides through at least one of the first and second conduits, and transferring a second stream comprising ethanol, methanol or a combination therefore through at least one of the first and second conduits, whereby the streams are transferred to spaces around the tapered rollers where they are compressed to generate sufficient heat and pressure to produce supercritical conditions under which the triglycerides and ethanol, methanol or combination thereof react to form bio-diesel and glycerol
